(19) United States
(12) Patent Application Publication
(10) Pub. No.: US 2025/0086736 A1
(43) Pub. Date: Mar. 13, 2025

(54) Serverless Computing for Portfolio Optimization Apparatuses, Processes and Systems

(71) Applicant: FMR LLC, Boston, MA (US)

(72) Inventors: Peng Sun, Apex, NC (US); Jiangtang Hu, Cary, NC (US); Niyu Jia, Malden, MA (US); Aaron Gao, Wayland, MA (US)

(21) Appl. No.: 18/367,438

(22) Filed: Sep. 12, 2023

(51) Int. Cl. G06Q 50/18

(52) U.S. Cl. CPC G06Q 50/184

(57) ABSTRACT

The Serverless Computing for Portfolio Optimization Apparatuses, Processes and Systems (“SCPO”) transforms optimization application configuration input, optimization application execution input datastructure/inputs via SCPO components into optimization application configuration output, optimization application execution output outputs. An optimization application configuration request associated with an optimization application and structured to specify a plurality of optimization modules to configure for the optimization application is obtained. A first optimization configuration datastructure structured to specify a first cloud function, a first API path, and an identifier of an application load balancer is generated for a first optimization module. A second optimization configuration datastructure structured to specify a second cloud function, a second API path, and the identifier of the application load balancer is generated for a second optimization module. The first optimization configuration datastructure and the second optimization configuration datastructure are provided to a cloud configuration server structured to configure the application load balancer.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address cloud computing, and more particularly, include Serverless Computing for Portfolio Optimization Apparatuses, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Serverless Computing for Portfolio Optimization Apparatuses, Processes and Systems (hereinafter “SCPO”) disclosure, include:

FIG. 1 shows non-limiting, example embodiments of an architecture for the SCPO;

FIG. 2 shows non-limiting, example embodiments of an architecture for the SCPO;

FIG. 3 shows non-limiting, example embodiments of a datagraph illustrating data flow(s) for the SCPO;

FIG. 4 shows non-limiting, example embodiments of a logic flow illustrating an optimization application configuration processing (OACP) component for the SCPO;

FIG. 5 shows non-limiting, example embodiments of a screenshot illustrating user interface(s) of the SCPO;

FIG. 6 shows non-limiting, example embodiments of a screenshot illustrating user interface(s) of the SCPO;

FIG. 7 shows non-limiting, example embodiments of a screenshot illustrating user interface(s) of the SCPO;

FIG. 8 shows non-limiting, example embodiments of a datagraph illustrating data flow(s) for the SCPO;

FIG. 9 shows non-limiting, example embodiments of a logic flow illustrating an optimization module execution processing (OMEP) component for the SCPO;

FIG. 10 shows non-limiting, example embodiments of a screenshot illustrating user interface(s) of the SCPO;

FIG. 11 shows non-limiting, example embodiments of a screenshot illustrating user interface(s) of the SCPO;

FIG. 12 shows non-limiting, example embodiments of implementation case(s) for the SCPO;

FIG. 13 shows non-limiting, example embodiments of implementation case(s) for the SCPO;

FIG. 14 shows non-limiting, example embodiments of implementation case(s) for the SCPO;

FIG. 15 shows a block diagram illustrating non-limiting, example embodiments of a SCPO controller.

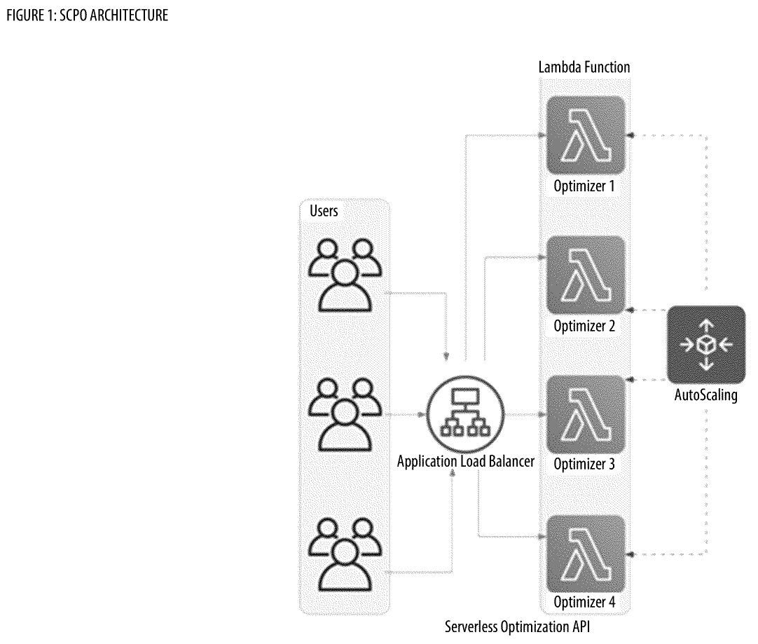

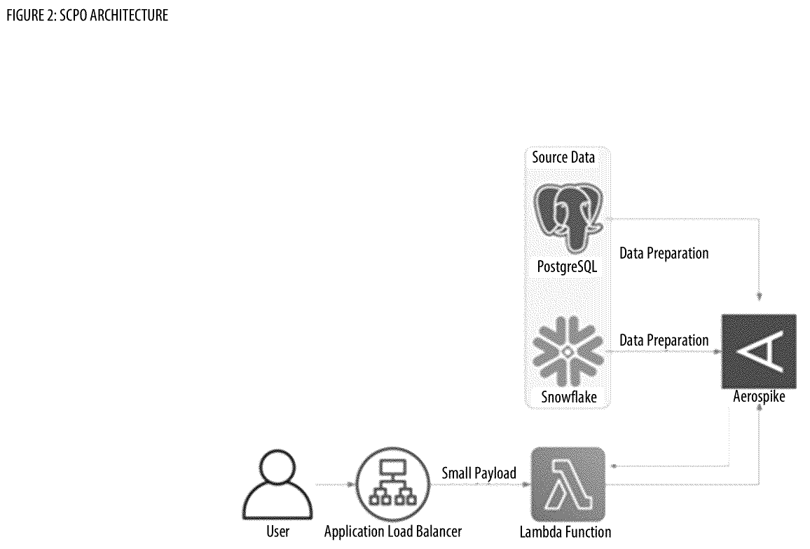

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Serverless Computing for Portfolio Optimization Apparatuses, Processes and Systems (hereinafter “SCPO”) transforms optimization application configuration input, optimization application execution input datastructure/inputs, via SCPO components (e.g., OACP, OMEP, etc. components), into optimization application configuration output, optimization application execution output outputs. The SCPO components, in various embodiments, implement advantageous features as set forth below.

### Introduction

The SCPO provides unconventional features (e.g., a serverless optimizer API for portfolio optimization using cloud functions (e.g., AWS Lambda Functions) to achieve high availability, high concurrency, and quick responsiveness) that were never before available in cloud computing.

Portfolio optimization is the process that helps investors analyze, optimize, and visualize multi-asset portfolios by providing optimal asset allocation and visualization demonstrations. Two of the mainstream optimizers that may be applied are Mean Variance Optimizer (MVO) and Tail Risk Optimizer (TRO). Those optimizers attempt to maximize the expected portfolio return while controlling the variance or the tail risk within a pre-defined risk tolerance level.

In MVO, the risk is defined as portfolio volatility and in TRO the risk is defined as portfolio loss, which can be computed using Conditional Value-at-Risk (CVaR) with user specified confidence level.

In one embodiment, an optimizer may find a set of asset allocation weights, such that:
Sum of asset weights equals to 1
Maximize the portfolio expected return
The risk is strictly restricted within a tolerance level (e.g., the portfolio volatility should be less than or equal to 10%; the portfolio loss should be less than or equal to 5%).

For the portfolio optimization types, MVO and TRO, there are multiple types of solvers that may be available. For example, commercial solvers, such as Gurobi, and open source solvers, such as CVXOPT, may be used. Thus, multiple portfolio optimization functions may be utilized based on optimization type and solver used.

In one embodiment, the outputs of the optimizers contain the optimal asset weights, the optimal portfolio expected return and its risk value. In another embodiment, an optimizer tool may also generate a visualization of frontiers that indicates the potential risk tolerance range and the efficient portfolios.

To visualize the efficient frontier, the optimizer may execute the optimization multiple times setting different pre-defined risk tolerance levels. The generation of the frontier usually involves calling the optimizer function hundreds of times and this process is extremely time-consuming even for some of the most popular and powerful solvers such as CVXOPT and Gurobi.

Typically, to generate the efficient frontier the optimizer tool needs at least over 50 points to shape the line from continuous dots. If a user requires higher accuracy, it may end up with drawing hundreds of points to shape a frontier curve. The MVO is a convex optimization problem and, in some implementations, may be executed fast with a large-sized portfolio. However, the TRO is a non-convex optimization problem that utilizes more resources and time to fetch the results, trying Simplex method and/or Interior-Point method. The computation complexity grows significantly as the number of assets in the portfolio increases, thus huge computation resources and memory are utilized to generate a single Return vs. Loss frontier.

For example, the performance decrease associated with an increase in portfolio size for a typical server machine (e.g., Intel Core i7 at 2.6 GHz with 6 processors and 16 GB of RAM) is shown below:

| | Benchmark | | Time Cost | Time Cost |
|---|---|---|---|---|
| Portfolio | Portfolio | | (seconds) | (seconds) |
| Size | Size | Method | Cvxopt | Gurobi |
| 15 | 13 | Interior | 309 | 4.5 |
| 15 | 13 | Simplex | 3.9 | 4.1 |
| 15 | 13 | Simplex | 67 | 28 |
| 16 | 12 | Simplex | 6 | 4.2 |
| 16 | 12 | Interior | 228 | 3.9 |
| 56 | 2 | Simplex | 10 | 4 |
| 56 | 2 | Interior | 337 | 4.7 |
| 148 | 0 | Interior | 303 | 8.6 |
| 148 | 0 | Simplex | 24 | 4.2 |
| 458 | 0 | Simplex | Unable to solve | 6.8 |
| 458 | 0 | Interior | Unable to solve | 12.3 |

The current industry standard to implement a portfolio optimization function is to build a server-based system. The pre-configured server machines are used to host all the source code and software dependencies, and they are also the only computing resources to return responses to users. This approach is hard to scale and not flexible. First, there is no built-in scaling mechanism to handle massive concurrent requests. Second, the server is always up and running, even if there are no incoming requests, which leads to unnecessary computing resource consumption.

For better scalability and computing resource control, the SCPO implements an optimization API using a serverless infrastructure, which scales automatically according to user requests and is utilized when the API is processing requests. This new approach makes scaling effortless and reduces the use of computing resources significantly. The energy efficient computing environment also helps to reduce a corporation's carbon footprint. In various embodiments, the serverless infrastructure may be implemented via Amazon AWS, Google Cloud, Microsoft Azure, and/or the like cloud platforms.

### SCPO

FIG. 1 shows non-limiting, example embodiments of an architecture for the SCPO. In FIG. 1, an embodiment of how a serverless optimization API may be implemented using cloud functions to achieve high availability, high concurrency, and quick responsiveness is illustrated. It is to be understood that AWS Lambda Functions, Google Cloud Functions, Azure Functions, and/or the like cloud functions may be utilized in various embodiments.

In one implementation, the cloud function based optimizer API may be placed behind an (e.g., AWS) Application Load Balancer (ALB) that may direct request traffic from end users. Since the ALB can route HTTP requests to a Lambda Function based on path, it may be used as the web server gateway when deploying a Lambda Function as a RESTful API service. In one implementation, the Lambda Functions may be integrated with the ALB as targets. The ALB may be structured to automatically distribute the incoming traffic from the users across multiple targets (e.g., across multiple Lambda Functions).

In one implementation, when a user makes a Lambda Function based API request, the AWS Lambda Function may create an instance of the function (e.g., Optimizer 1) to process the event. In some implementations, AWS Lambda Function's provisioned concurrency service may be utilized to initialize a desired number of instances (e.g., 1000 reserved concurrency capacity) to achieve quick response times during predictable high traffic periods. When the API returns a response, it may be structured to be active (e.g., warm state) for some period of time (e.g., 5 minutes) waiting for additional requests. The warm state may make the following API call faster, since it saves the time to initiate a new instance. The Lambda Function may be structured to automatically scale up or scale down the instances according to the volume of API requests.

In one implementation, the architecture of the serverless optimization API may be structured as follows:
The users send out API requests.
The Application Load Balancer redirects the traffic to specific Lambda Functions according to API links sent from users and/or according to the users' regions.
For the Lambda Functions which receive the requests, the system may initiate computing instances, perform the calculation, and return results to users.
If the incoming volume of requests is reaching the limit of the default number of instances assigned (e.g., 1000 in AWS Lambda Function), the autoscaling mechanism may be triggered, and more instances may be spawned to meet the requests.
After the results are sent, the instances may wait for another 5 minutes to take following requests; if none, the instances may be terminated.

FIG. 2 shows non-limiting, example embodiments of an architecture for the SCPO. In FIG. 2, additional details regarding how the serverless optimization API may be implemented using cloud functions is illustrated. Because serverless cloud functions (e.g., AWS Lambda Functions, Google Cloud Functions, Azure Functions) are designed for lightweight applications, multiple engineering innovations may be utilized to make the serverless cloud functions operational for computationally heavy tasks like portfolio optimization.

For a Lambda Function, the uncompressed deployment package and library dependencies have a size limitation of 250 MB, which is far less than the code size of a server-based optimizer system. In one implementation, the serverless optimization API may be structured to utilize multiple optimization modules (e.g., via separate Lambda Functions), for example split according to optimization types, which may also utilize separate library dependencies. This separation facilitates a flatter API and reduces the execution time.

To keep the light weight of the serverless cloud functions, a minimized set of libraries is utilized for each Lambda Function. The dependencies may be deployed separately to AWS Lambda Function Layers, an AWS service to archive code, library, and/or runtimes, and each Lambda Function may be structured to point to the specific utilized Layers (e.g., some of which may be shared among different Lambda Functions). Such separation of Lambda Functions and Layers may facilitate faster application deployment and/or maintenance.

AWS Lambda Functions, like other lightweight serverless computing services, put a hard limit (e.g., 6 MB) on invocation payload. When integrated with another service, the size is even smaller. For example, when integrating a Lambda Function as an AWS Application Load Balancer target, the maximum size is 1 MB. The portfolio optimization functions may utilize years of historical return data as inputs, which can be huge in size as the number of securities grows. For example, when there are 500 securities in a portfolio, the input data may be more than 20 MB, which is far larger than a Lambda Function could handle. To bypass the payload limit, the payload may be structured to contain minimum security identification information, while large historical data may be stored to a distributed in-memory database (e.g., Aerospike). The cached historical data may be quickly retrieved and provided to the Lambda Functions. In one implementation, for portfolio management, the source data may be stored in a traditional row-based database (e.g., PostgreSQL) and/or data warehouse (e.g., Snowflake). For example, PostgreSQL may be utilized for transactional purposes, while Snowflake for reporting and analytics. In order to achieve instant response times for a portfolio optimization API, a data cache layer may be added (e.g., via Aerospike, an in-memory distributed key value NoSQL database) to deliver predictably high performance.

In one implementation, the architecture of the serverless optimization API may be structured as follows:
Historical data in PostgreSQL and Snowflake may be loaded to in-memory database Aerospike.
Users may send small payloads to the optimizer API. The small payloads may be structured to contain minimum security metadata (e.g., security identifiers).
The API may retrieve historical data from Aerospike according to the security identifiers in the small payloads.
The API may perform the calculation and send results back to the users.

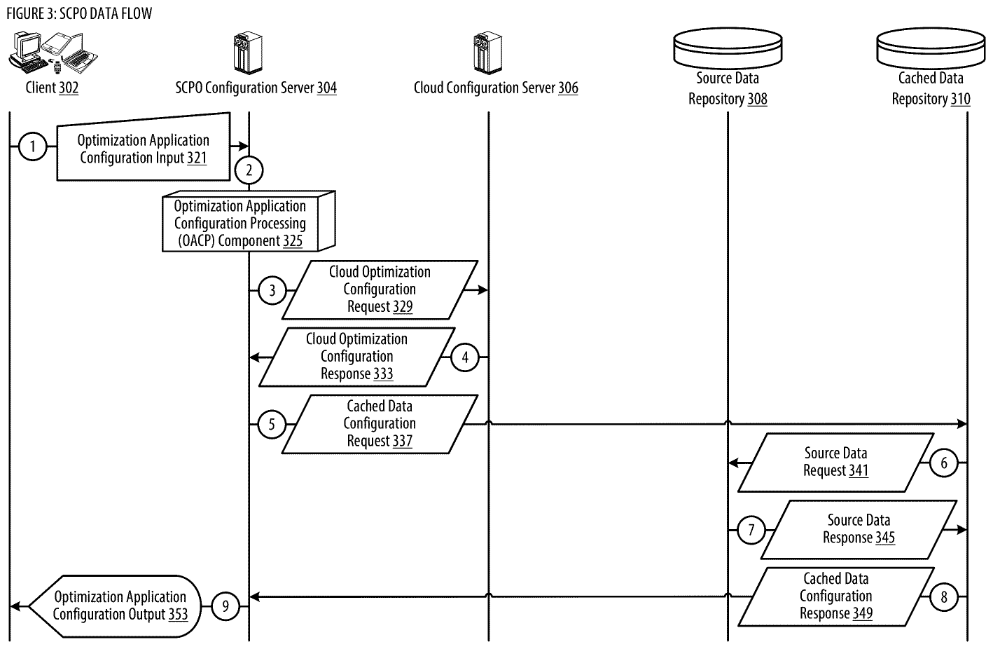

FIG. 3 shows non-limiting, example embodiments of a datagraph illustrating data flow(s) for the SCPO. In FIG. 3, a client 302 (e.g., of a user) may send an optimization application configuration input 321 to a SCPO configuration server 304 to facilitate configuring an optimization application (e.g., a portfolio optimizer). For example, the client may be a desktop, a laptop, a tablet, a smartphone, a smartwatch, and/or the like that is executing a client application. In one implementation, the optimization application configuration input may include data such as a request identifier, optimization application configuration data, and/or the like. In one embodiment, the client may provide the following example optimization application configuration input, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
          <user_name>JohnDaDoeDoeDoooe@gmail.com</user_name>
          <password>abc123</password>
          //OPTIONAL <cookie>cookieID</cookie>
          //OPTIONAL <digital_cert_link>www.mydigitalcertificate.com/
JohnDoeDaDoeDoe@gmail.com/mycertifcate.dc</digital_cert_link>
          //OPTIONAL <digital_certificate>_DATA _</digital_certificate>
      </user_account_credentials>
  </user_accounts_details>
  <client_details> //iOS Client with App and Webkit
          //it should be noted that although several client details
          //sections are provided to show example variants of client
          //sources, further messages may include only one to save
          //space
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>SCPO.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <optimization_application_configuration_input>
    <request_identifier>ID_request_1</request_identifier>
    <optimization_application_configuration_data>
      <application_identifier>ID_optimizer_app_1</application_identifier>
      <application_type>TYPE_PORTFOLIO_OPTIMIZER</application_type>
      <application_modules>
        <optimization_module>MODULE_MVO_GUROBI</optimization_module>
        <optimization_module>MODULE_MVO_CVXOPT</optimization_module>
        <optimization_module>MODULE_CVAR_GUROBI</optimization_module>
        <optimization_module>MODULE_CVAR_CVXOPT</optimization_module>
      </application_modules>
      <application_cached_data_repository_settings>
        DB_AEROSPIKE_IP_ADDRESS:DB_AEROSPIKE_PORT
      </application_cached_data_repository_settings>
      <application_cached_data>HISTORICAL_RETURNS</application_cached_data>
      <application_load_balancer>
        portfolio_optimizer_alb
      </application_load_balancer>
    </optimization_application_configuration_data>
  </optimization_application_configuration_input>
</auth_request>
```

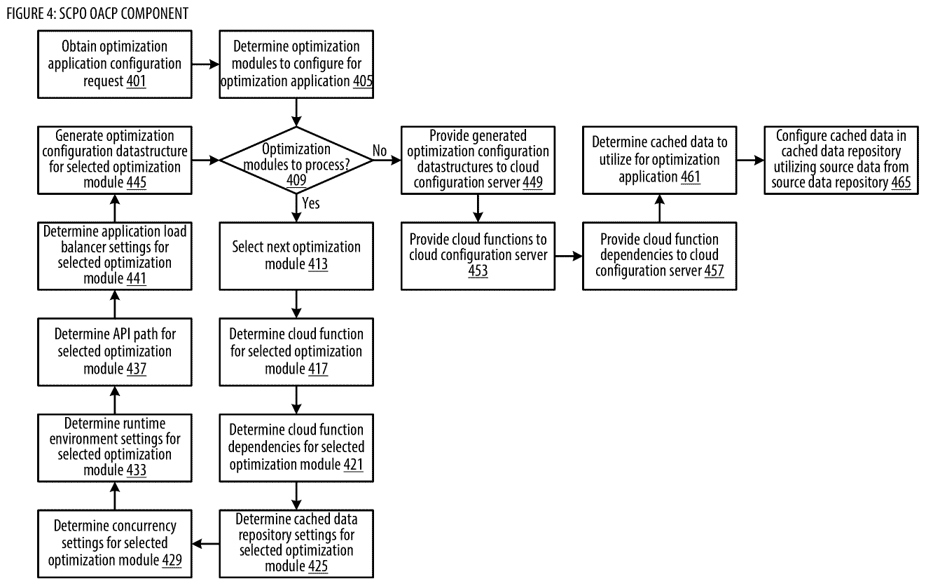

An optimization application configuration processing (OACP) component 325 may utilize data provided in the optimization application configuration input to configure the optimization application in accordance with the specified optimization application configuration data. See FIG. 4 for additional details regarding the OACP component.

The SCPO configuration server 304 may send a cloud optimization configuration request 329 to a cloud configuration server 306 to facilitate configuring cloud functions implementing a serverless optimization API for the optimization application. In one implementation, the cloud optimization configuration request may include data such as a request identifier, optimization configuration datastructure(s), cloud function code base(s) (e.g., deployment package(s) with a code base for each cloud function and/or each respective cloud function's library dependencies), and/or the like. It is to be understood that, in various implementations, one or multiple cloud optimization configuration requests may be sent to transfer such data. In one embodiment, the SCPO configuration server may provide the following example cloud optimization configuration request, substantially in the form of a HTTP(S) POST message including XML-formatted data, as provided below:

```
POST /cloud_optimization_configuration_request.php HTTP/1.1
Host: www.server.com
Content-Type: Application/XML
Content-Length: 667
<?XML version = “1.0” encoding = “UTF-8”?>
<cloud_optimization_configuration_request>
  <request_identifier>ID_request_2</request_identifier>
  <application_identifier>ID_optimizer_app_1</application_identifier>
  <optimization_configuration_datastructure>
    <optimization_module>MODULE_MVO_GUROBI</optimization_module>
    <cloud_function_description>
      Lambda Function MVO GUROBI
    </cloud_function_description>
    <cloud_function_handler>
      lambda_function_mvo_gurobi_handler
    </cloud_function_handler>
    <cloud_function_dependencies>
      lambda_layer:mvo_gurobi_lambda_layer_1
    </cloud_function_dependencies>
    <cached_data_repository_settings>
      DB_AEROSPIKE_IP_ADDRESS:DB_AEROSPIKE_PORT
    </cached_data_repository_settings>
    <concurrency_settings>1000</concurrency_settings>
    <runtime_environment_settings>
      lambda_runtime:python3.8
      lambda_memory_size:10240
      lambda_ephemeral_storage_size:512
    </runtime_environment_settings>
    <API_path>/investments/optimize/lambda_mvo_gurobi</API_path>
    <ALB_settings>
      application_load_balancer:portfolio_optimizer_alb
    </ALB_settings>
  </optimization_configuration_datastructure>
  <optimization_configuration_datastructure>
    <optimization_module>MODULE_MVO_CVXOPT</optimization_module>
    <cloud_function_description>
      Lambda Function MVO CVXOPT
    </cloud_function_description>
    <cloud_function_handler>
      lambda_function_mvo_cvxopt_handler
    </cloud_function_handler>
    <cloud_function_dependencies>
      lambda_layer:mvo_cvxopt_lambda_layer_1
    </cloud_function_dependencies>
    <cached_data_repository_settings>
      DB_AEROSPIKE_IP_ADDRESS:DB_AEROSPIKE_PORT
    </cached_data_repository_settings>
    <concurrency_settings>1000</concurrency_settings>
    <runtime_environment_settings>
      lambda_runtime:python3.8
      lambda_memory_size:10240
      lambda_ephemeral_storage_size:512
    </runtime_environment_settings>
    <API_path>/investments/optimize/lambda_mvo_cvxopt</API_path>
    <ALB_settings>
      application_load_balancer:portfolio_optimizer_alb
    </ALB_settings>
  </optimization_configuration_datastructure>
  ...
</cloud_optimization_configuration_request>
```

The cloud configuration server 306 may send a cloud optimization configuration response 333 to the SCPO configuration server 304 to confirm whether the cloud functions implementing the serverless optimization API for the optimization application were configured successfully. In one implementation, the cloud optimization configuration response may include data such as a response identifier, a status, and/or the like. In one embodiment, the cloud configuration server may provide the following example cloud optimization configuration response, substantially in the form of a HTTP(S) POST message including XML-formatted data, as provided below:

```
POST /cloud_optimization_configuration_response.php HTTP/1.1
Host: www.server.com
Content-Type: Application/XML
Content-Length: 667
<?XML version = “1.0” encoding = “UTF-8”?>
<cloud_optimization_configuration_response>
  <response_identifier>ID_response_2</response_identifier>
  <status>OK</status>
</cloud_optimization_configuration_response>
```

The SCPO configuration server 304 may send a cached data configuration request 337 to a cached data repository 310 (e.g., Aerospike) to facilitate configuring cached data for the optimization application. In one implementation, the cached data configuration request may include data such as a request identifier, cached data configuration settings, and/or the like. In one embodiment, the SCPO configuration server may provide the following example cached data configuration request, substantially in the form of a HTTP(S) POST message including XML-formatted data, as provided below:

```
POST /cached_data_configuration_request.php HTTP/1.1
Host: www.server.com
Content-Type: Application/XML
Content-Length: 667
<?XML version = “1.0” encoding = “UTF-8”?>
<cached_data_configuration_request>
  <request_identifier>ID_request_3</request_identifier>
  <cached_data_configuration_settings>
    <source_data>
      <source_data_repository_settings>
        DB_POSTGRE_SQL_IP_ADDRESS:DB_POSTGRE_SQL_PORT
      </source_data_repository_settings>
      <source_data_to_obtain>
        specification of historical securities data to obtain
      <source_data_to_obtain>
    </source_data>
    <source_data>
      <source_data_repository_settings>
        DB_SNOWFLAKE_IP_ADDRESS:DB_SNOWFLAKE_PORT
      </source_data_repository_settings>
      <source_data_to_obtain>
        specification of historical securities data to obtain
      <source_data_to_obtain>
    </source_data>
  </cached_data_configuration_settings>
</cached_data_configuration_request>
```

The cached data repository 310 may send a source data request 341 to a source data repository 308 to obtain specified source data. In one implementation, the source data request may include data such as a request identifier, specification of source data to obtain, and/or the like. In one embodiment, the cached data repository may provide the following example source data request, substantially in the form of a HTTP(S) POST message including XML-formatted data, as provided below:

```
POST /source_data_request.php HTTP/1.1
Host: www.server.com
Content-Type: Application/XML
Content-Length: 667
<?XML version = “1.0” encoding = “UTF-8”?>
<source_data_request>
  <request_identifier>ID_request_4</request_identifier>
  <source_data_to_obtain>
    specification of historical securities data to obtain
  <source_data_to_obtain>
</source_data_request>
```

The source data repository 308 may send a source data response 345 to the cached data repository 310 with the requested source data. In one implementation, the source data response may include data such as a response identifier, the requested source data, and/or the like. In one embodiment, the source data repository may provide the following example source data response, substantially in the form of a HTTP(S) POST message including XML-formatted data, as provided below:

```
POST /source_data_response.php HTTP/1.1
Host: www.server.com
Content-Type: Application/XML
Content-Length: 667
<?XML version = “1.0” encoding = “UTF-8”?>
<source_data_response>
  <response_identifier>ID_response_4</response_identifier>
  <source_data>the requested source data</source_data>
</source_data_response>
```

The cached data repository 310 may send a cached data configuration response 349 to the SCPO configuration server 304 to confirm whether the cached data for the optimization application was configured successfully. In one implementation, the cached data configuration response may include data such as a response identifier, a status, and/or the like. In one embodiment, the cached data repository may provide the following example cached data configuration response, substantially in the form of a HTTP(S) POST message including XML-formatted data, as provided below:

```
POST /cached_data_configuration_response.php HTTP/1.1
Host: www.server.com
Content-Type: Application/XML
Content-Length: 667
<?XML version = “1.0” encoding = “UTF-8”?>
<cached_data_configuration_response>
  <response_identifier>ID_response_3</response_identifier>
  <status>OK</status>
</cached_data_configuration_response>
```

The SCPO configuration server 304 may send an optimization application configuration output 353 to the client 302 to inform the user whether the optimization application was configured successfully. In one implementation, the optimization application configuration output may include data such as a response identifier, a status, and/or the like. In one embodiment, the SCPO configuration server may provide the following example optimization application configuration output, substantially in the form of a HTTP(S) POST message including XML-formatted data, as provided below:

```
POST /optimization_application_configuration_output.php HTTP/1.1
Host: www.server.com
Content-Type: Application/XML
Content-Length: 667
<?XML version = “1.0” encoding = “UTF-8”?>
<optimization_application_configuration_output>
  <response_identifier>ID_response_1</response_identifier>
  <status>OK</status>
</optimization_application_configuration_output>
```

FIG. 4 shows non-limiting, example embodiments of a logic flow illustrating an optimization application configuration processing (OACP) component for the SCPO. In FIG. 4, an optimization application configuration request may be obtained at 401. For example, the optimization application configuration request may be obtained as a result of a request from a user to configure an optimization application (e.g., a portfolio optimizer).

Optimization modules to configure for the optimization application may be determined at 405. In one embodiment, a plurality of optimization (e.g., optimizer and/or solver) configurations (e.g., portfolio optimizer/solver configurations (e.g., Gurobi/MVO, Gurobi/CVAR, CVXOPT/MVO, CVXOPT/CVAR)) may be utilized by the optimization application, and a distinct optimization module may be utilized for each of the (e.g., portfolio) optimization configurations. In one implementation, the optimization application configuration request may be parsed (e.g., using PHP commands) to determine the optimization modules to configure for the optimization application (e.g., based on the value of the application_modules field). In another implementation, the user may be prompted to specify the optimization modules to configure for the optimization application via a user interface of the SCPO.

A determination may be made at 409 whether there remain optimization modules to process. In one implementation, each of the optimization modules to configure for the optimization application may be processed. If there remain optimization modules to process, the next optimization module may be selected for processing at 413.

A cloud function for the selected optimization module may be determined at 417. In one embodiment, optimization module configuration settings such as a code base for the cloud function (e.g., including a handler function that is called to process a request sent to the cloud function), a description of the cloud function, and/or the like may be determined. In one implementation, the optimization application configuration request may be parsed (e.g., using PHP commands) to determine optimization module configuration settings for the cloud function (e.g., based on the value of the optimization_application_configuration_data field). In another implementation, the user may be prompted to specify optimization module configuration settings for the cloud function via a user interface of the SCPO.

Cloud function dependencies for the selected optimization module may be determined at 421. In one embodiment, optimization module configuration settings such as a code base for the cloud function dependencies, a description of the cloud function dependencies, and/or the like may be determined. In one implementation, the optimization application configuration request may be parsed (e.g., using PHP commands) to determine optimization module configuration settings for the cloud function dependencies (e.g., based on the value of the optimization_application_configuration_data field). In another implementation, the user may be prompted to specify optimization module configuration settings for the cloud function dependencies via a user interface of the SCPO.

Cached data repository settings for the selected optimization module may be determined at 425. In one embodiment, optimization module configuration settings such as a cached data repository type (e.g., Aerospike), an IP address and/or port of a cached data repository, and/or the like may be determined. In one implementation, the optimization application configuration request may be parsed (e.g., using PHP commands) to determine the cached data repository settings (e.g., based on the value of the application_cached_data_repository_settings field). In another implementation, the user may be prompted to specify the cached data repository settings via a user interface of the SCPO.

Concurrency settings for the selected optimization module may be determined at 429. In one embodiment, optimization module configuration settings such as a default number of concurrent cloud function instances, a maximum number of concurrent cloud function instances, and/or the like may be determined. In one implementation, the optimization application configuration request may be parsed (e.g., using PHP commands) to determine the concurrency settings (e.g., based the value of optimization_application_configuration_data field). In another implementation, the user may be prompted to specify the concurrency settings via a user interface of the SCPO.

Runtime environment settings for the selected optimization module may be determined at 433. In one embodiment, optimization module configuration settings such as a runtime environment (e.g., Python 3.8), an architecture (e.g., x86_64), a memory size, an ephemeral storage size, and/or the like may be determined. In one implementation, the optimization application configuration request may be parsed (e.g., using PHP commands) to determine the runtime environment settings (e.g., based on the value of the optimization_application_configuration_data field). In another implementation, the user may be prompted to specify the runtime environment settings via a user interface of the SCPO.

An API path for the selected optimization module may be determined at 437. In one embodiment, optimization module configuration settings such as the API path to utilize to route requests to the cloud function (e.g., to the handler function), and/or the like may be determined. In one implementation, the optimization application configuration request may be parsed (e.g., using PHP commands) to determine the API path (e.g., based on the value of the optimization_application_configuration_data field). In another implementation, the user may be prompted to specify the API path via a user interface of the SCPO.

Application load balancer settings for the selected optimization module may be determined at 441. In one embodiment, optimization module configuration settings such as an identifier of an ALB to utilize, and/or the like may be determined. In one implementation, the optimization application configuration request may be parsed (e.g., using PHP commands) to determine the application load balancer settings (e.g., based on the value of the application_load_balancer field). In another implementation, the user may be prompted to specify the application load balancer settings via a user interface of the SCPO.

An optimization configuration datastructure for the selected optimization module may be generated at 445. In one embodiment, the optimization configuration datastructure may be structured to store the determined optimization module configuration settings. In one implementation, the optimization configuration datastructure may be generated using PHP commands. For example, the optimization configuration datastructure may be generated via a CloudFormation template and may be similar to the following (e.g., partial configuration):

| Lambda Function | |
|---|---|
| Configurations | CloudFormation Template |
| Programming Language | “LambdaRuntime”: “python3.8” |
| Memory | “LambdaMemorySize”: “10240” |
| Lambda Layers | “LambdaLayer”: “ap147494-atim- |
| | mvo-gurobi-lambda-layer” |
| Load Balancer | “ApplicationLoadBalancer”: |
| | “ap147494-dev-optimizer-ati-alb” |
| API Path | “PathPattern”: “/investments/ |
| | optimize/lambda_mvo_gurobi” |
| . . . | . . . |

The generated optimization configuration datastructures associated with the optimization modules to configure for the optimization application may be provided to a cloud configuration server at 449. In one implementation, the generated optimization configuration datastructure may be provided to the cloud configuration server via one or more cloud optimization configuration requests.

Cloud functions associated with the optimization modules to configure for the optimization application may be provided to the cloud configuration server at 453. In one implementation, deployment package(s) with a code base for each cloud function may be provided to the cloud configuration server via one or more cloud optimization configuration requests.

Cloud function dependencies associated with the optimization modules to configure for the optimization application may be provided to the cloud configuration server at 457. In one implementation, deployment package(s) with a code base for each cloud function's library dependencies may be provided to the cloud configuration server via one or more cloud optimization configuration requests.

Cached data to utilize for the optimization application may be determined at 461. For example, a portfolio optimization application may utilize cached historical performance data for a set of securities. In one embodiment, cached data settings such as source data repository settings (e.g., an IP address and/or port of a source data repository), specification of source data to obtain, and/or the like may be determined. In one implementation, the optimization application configuration request may be parsed (e.g., using PHP commands) to determine the cached data to utilize for the optimization application (e.g., based on the values of the application_cached_data and/or application_cached_data_repository_settings fields). In another implementation, the user may be prompted to specify the cached data to utilize for the optimization application via a user interface of the SCPO.

Cached data may be configured in a cached data repository utilizing source data from one or more source data repositories at 465. In one embodiment, the cached data repository may be instructed to retrieve source data from the one or more source data repositories, and/or to transform the retrieved source data into a cached data format utilized by the cached data repository, and/or to store the corresponding cached data in the cached data repository. In one implementation, the cached data may be configured in the cached data repository via one or more cached data configuration requests.

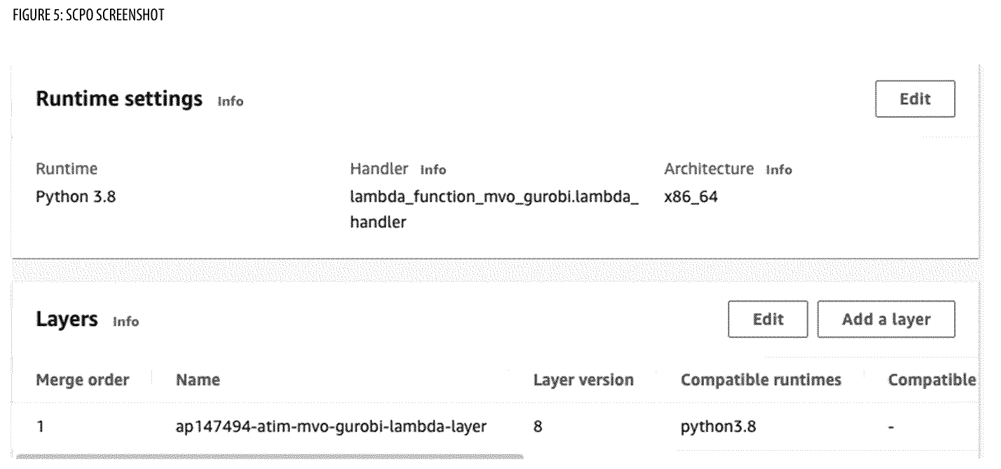

FIG. 5 shows non-limiting, example embodiments of a screenshot illustrating user interface(s) of the SCPO. In FIG. 5, an exemplary user interface (e.g., for AWS Lambda Function portal) showing configuration settings for an optimization module (e.g., implemented via an AWS Lambda Function) of an optimization application is illustrated. Runtime settings, such as a runtime (e.g., Python 3.8), a cloud function handler (e.g., the function executed to perform the calculation), an architecture (e.g., x86_64), may be shown and/or modified. Layers settings, such as configuration data for cloud function dependencies (e.g., via AWS Lambda Function Layers) may be shown and/or modified.

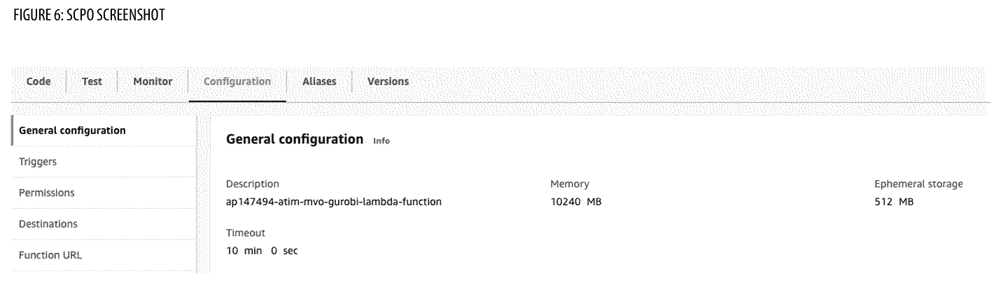

FIG. 6 shows non-limiting, example embodiments of a screenshot illustrating user interface(s) of the SCPO. In FIG. 6, an exemplary user interface (e.g., for AWS Lambda Function portal) showing configuration settings for an optimization module (e.g., implemented via an AWS Lambda Function) of an optimization application is illustrated. General configuration settings, such as a cloud function description, a timeout period (e.g., 10 minutes), computing capacity (e.g., 10240 MB of memory and 512 MB of storage), may be shown and/or modified.

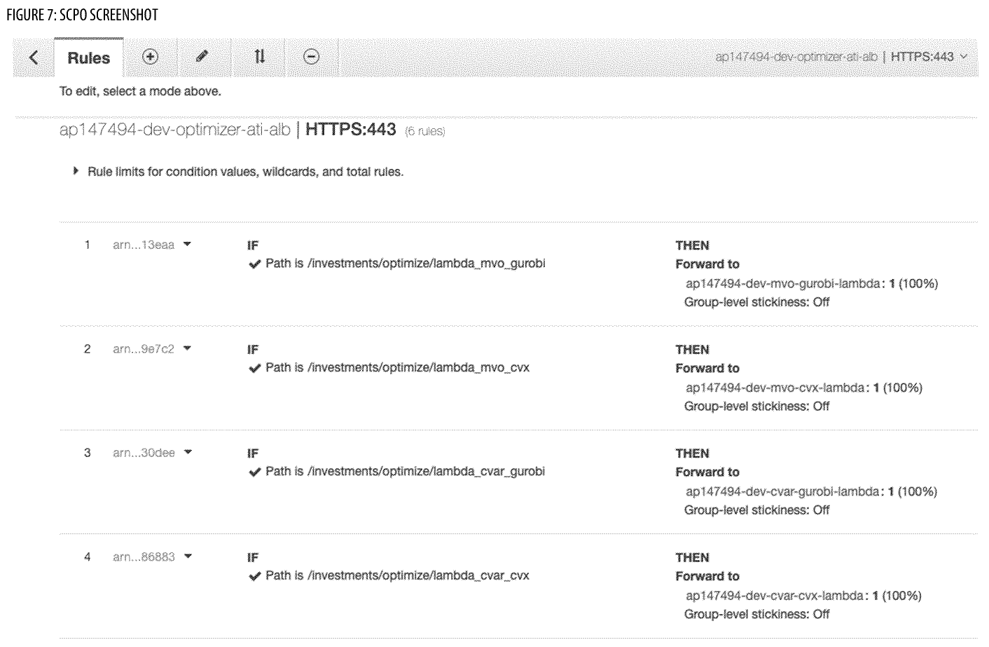

FIG. 7 shows non-limiting, example embodiments of a screenshot illustrating user interface(s) of the SCPO. In FIG. 7, an exemplary user interface showing configuration settings (e.g., implemented via AWS ALB) for an optimization application is illustrated. In one implementation, when a Lambda Function API URL is called by users, the AWS ALB may reroute the requests to a specific optimization module (e.g., implemented via an AWS Lambda Function) according to the URL path. For example, these path may be specified in the AWS ALB individually as shown.

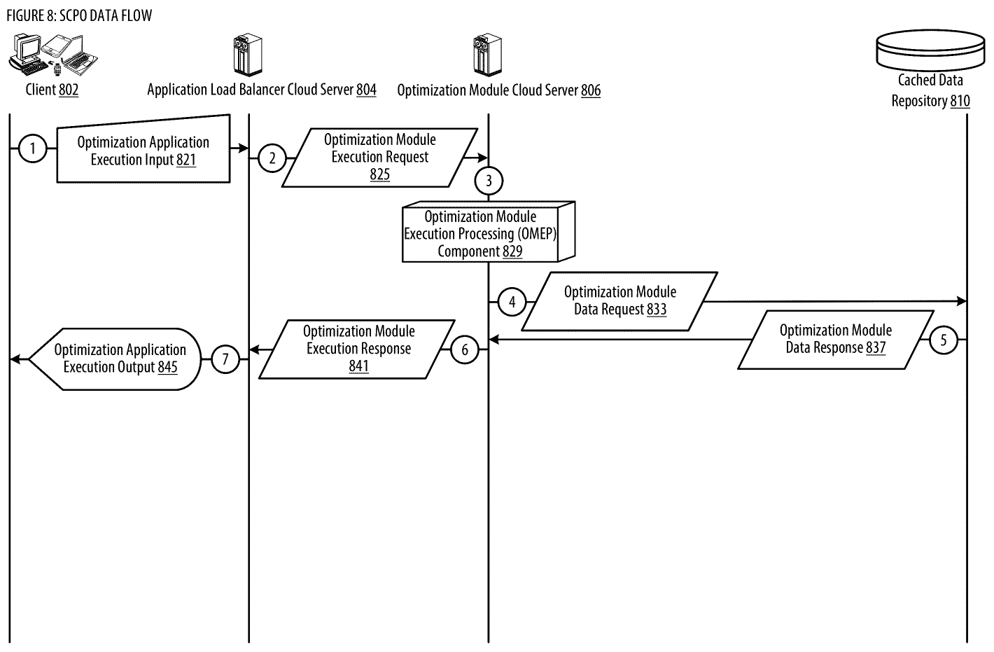

FIG. 8 shows non-limiting, example embodiments of a datagraph illustrating data flow(s) for the SCPO. In FIG. 8, a client 802 (e.g., of a user) may send an optimization application execution input 821 (e.g., an optimization request) to an application load balancer cloud server 804 to facilitate execution of an optimization application (e.g., a portfolio optimizer). For example, the client may be a desktop, a laptop, a tablet, a smartphone, a smartwatch, and/or the like that is executing a client application. In one implementation, the optimization application execution input may include data such as a request identifier, optimization application input data, and/or the like. In one embodiment, the client may provide the following example optimization application execution input, substantially in the form of a HTTP(S) POST message including XML-formatted data, as provided below:

```
POST /API_PATH HTTP/1.1
Host: www.server.com
Content-Type: Application/XML
Content-Length: 667
<?XML version = “1.0” encoding = “UTF-8”?>
<optimization_application_execution_input>
  <request_identifier>ID_request_11</request_identifier>
  <optimization_application_input_data>
    <portfolioMarketValue>10000000</portfolioMarketValue>
    <solver>1 (e.g., Gurobi)</solver>
    <isRelative>false</isRelative>
    <optimizerType>1 (e.g., MVO)</optimizerType>
    <mvo>
      <volThreshold>0.1</volThreshold>
    </mvo>
    <portfolioAssets>
      <asset>ID_security_1</asset>
      <asset>ID_security_2</asset>
      ...
    </portfolioAssets>
  </optimization_application_input_data>
</optimization_application_execution_input>
```

The application load balancer cloud server 804 may send an optimization module execution request 825 to an optimization module cloud server 806 to forward the optimization request to an instance of an optimization module of the optimization application responsible for handling the optimization request (e.g., based on the specified API path).

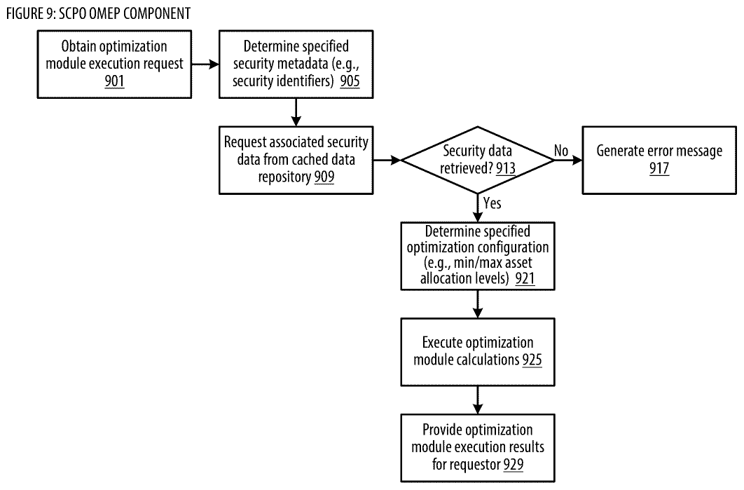

An optimization module execution processing (OMEP) component 829 may utilize data provided in the optimization request to execute the optimization application in accordance with the specified optimization application input data. See FIG. 9 for additional details regarding the OMEP component.

The optimization module cloud server 806 may send an optimization module data request 833 to a cached data repository 810 to obtain cached data utilized by the optimization application to process the optimization request. In one implementation, the optimization module data request may include data such as a request identifier, specification of cached data to obtain (e.g., via a set of security identifiers), and/or the like. In one embodiment, the optimization module cloud server may provide the following example optimization module data request, substantially in the form of a HTTP(S) POST message including XML-formatted data, as provided below:

```
POST /optimization_module_data_request.php HTTP/1.1
Host: www.server.com
Content-Type: Application/XML
Content-Length: 667
<?XML version = “1.0” encoding = “UTF-8”?>
<optimization_module_data_request>
  <request_identifier>ID_request_13</request_identifier>
  <portfolioAssets>
    <asset>ID_security_1</asset>
    <asset>ID_security_2</asset>
    ...
  </portfolioAssets>
</optimization_module_data_request>
```

The cached data repository 810 may send an optimization module data response 837 to the optimization module cloud server 806 with the requested cached data. In one implementation, the optimization module data response may include data such as a response identifier, the requested cached data (e.g., asset return distribution for the set of security identifiers), and/or the like. In one embodiment, the cached data repository may provide the following example optimization module data response, substantially in the form of a HTTP(S) POST message including XML-formatted data, as provided below:

```
POST /optimization_module_data_response.php HTTP/1.1
Host: www.server.com
Content-Type: Application/XML
Content-Length: 667
<?XML version = “1.0” encoding = “UTF-8”?>
<optimization_module_data_response>
  <response_identifier>ID_response_13</response_identifier>
  <cached_data>the requested cached data</cached_data>
</optimization_module_data_response>
```

The optimization module cloud server 806 may send an optimization module execution response 841 to the application load balancer cloud server 804 with the requested optimization application output data (e.g., optimal asset weights for the specified portfolio assets, optimal portfolio expected return, data specifying charts of efficient frontiers, and/or the like). In one implementation, the optimization module execution response may include data such as a response identifier, the requested optimization application output data, and/or the like. In one embodiment, the optimization module cloud server may provide the following example optimization module execution response, substantially in the form of a HTTP(S) POST message including XML-formatted data, as provided below:

```
POST /optimization_module_execution_response.php HTTP/1.1
Host: www.server.com
Content-Type: Application/XML
Content-Length: 667
<?XML version = “1.0” encoding = “UTF-8”?>
<optimization_module_execution_response>
  <response_identifier>ID_response_12</response_identifier>
  <optimization_application_output_data>
    the requested optimization application output data
  </optimization_application_output_data>
</optimization_module_execution_response>
```

The application load balancer cloud server 804 may send an optimization application execution output 845 to the client 802 to forward the requested optimization application output data to the user (e.g., to be provided to the user via a user interface of the SCPO).

FIG. 9 shows non-limiting, example embodiments of a logic flow illustrating an optimization module execution processing (OMEP) component for the SCPO. In FIG. 9, an optimization module execution request (e.g., an optimization request) may be obtained by an optimization module of an optimization application at 901. For example, the optimization module execution request may be obtained as a result of a request from a user to execute the optimization application (e.g., a portfolio optimizer). In one implementation, the optimization module execution request may be specified via JSON file containing data fields similar to the following

| Field Name | Type | Description |
|---|---|---|
| portfolioMarketValue | String | total portfolio market value |
| solver | int | the solver type of optimization |
| | | (e.g., 0 for open-source solver |
| | | (e.g., cvxpy) and 1 for gurobi solver) |
| isRelative | Boolean | the boolean variable to indicate |
| | | relative mode. If enabled, |
| | | Benchmark is utilized |
| optimizerType | int | the type of optimizer (e.g., may |
| | | be chosen from the following |
| | | 2 types: |
| | | For OptimizerType = 1; mean |
| | | variance model, mvo field is |
| | | utilized |
| | | For OptimizerType = 2; cvar |
| | | model, tailRisk field is utilized |
| riskToleranceRange | Boolean | the boolean variable indicating |
| | | whether the min-max risk |
| | | should be returned |
| benchmarkAssets* | List of dict | list of the benchmark asset* dictionary |
| portfolioAssets* | List of dict | list of the portfolio asset* dictionary |
| mvo* | dict | the mvo object, for mean |
| | | variance optimizer |
| tailRisk* | dict | the tail risk object, for tail |
| | | risk optimizer |
| groups* | List of dict | list of the group level |
| | | constrains* object |

For fields starred in the table above, the data structure is nested and may contain data fields similar to the following:

Benchmark asset

| Field Name | Type | Description |
|---|---|---|
| id | string | asset id |
| weight | string | weight of the asset |
| returnDistribution | list of strings | the asset simulation array |
| returnAssumption | string | The return assumption of asset |

Portfolio asset

| Field Name | Type | Description |
|---|---|---|
| id | string | asset id |
| weight | string | the initial weight of the asset |
| returnDistribution | list of strings | the asset simulation array |
| returnAssumption | string | the expected return of asset |
| price | string | asset price |
| allocationLb | string | asset allocation lower bound |
| allocationUb | string | asset allocation upper bound |
| minDenom | string | the minimum quantity if |
| | | investors want to hold the asset |
| minIncre | string | minimum increment in quantity |
| grouplds | list of ints | the id of the self-defined |
| | | security group. It should be |
| | | between 0 to 9 |

mvo

| Field Name | Type | Description |
|---|---|---|
| volThreshold | string | the volatility threshold of portfolio |

tailRisk

| Field Name | Type | Description |
|---|---|---|
| cvarThreshold | string | the CVaR threshold of portfolio |
| cvarPercentile | string | the percentage of worst |
| | | cases to compute CVaR |

groups

| Field Name | Type | Description |
|---|---|---|
| id | int | the id of the self-defined |
| | | security group |
| allocation | list of | allocation limit (min-max) |
| | strings | for each group |

Specified security metadata (e.g., a set of security identifiers) associated with the optimization request may be determined at 905. For example, security identifiers such as tickers, CUSIPS, and/or the like may be specified. In one implementation, the optimization request may be parsed (e.g., using PHP commands) to determine the specified security metadata (e.g., based on the value of the portfolio Assets field).

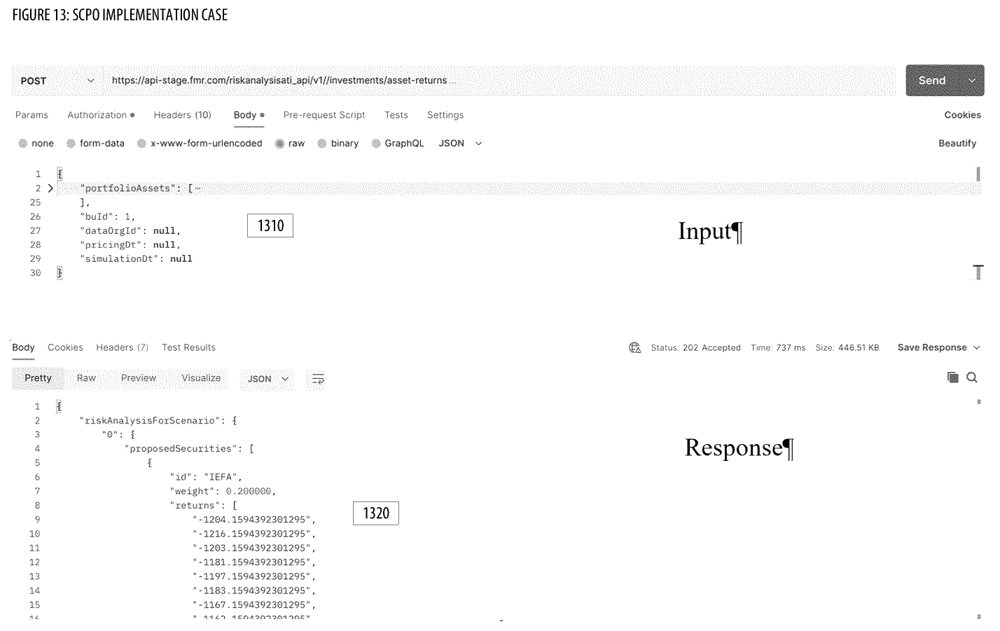

Associated security data may be requested from a cached data repository at 909. For example, asset return distribution for the set of security identifiers may be requested. In one implementation, an API call to fetch the associated security data from an Aerospike database may be made (e.g., via an optimization module data request). See FIG. 13 for an example of an API call that may be made.

A determination may be made at 913 whether the requested security data was retrieved successfully. If not, an error message may be generated at 917. For example, the error message may indicate that the optimization application was unable to process the optimization request because the associated security data was not retrieved successfully

If the requested security data was retrieved successfully, a specified optimization configuration may be determined at 921. For example, min and/or max asset allocation levels may be determined. In one implementation, the optimization request may be parsed (e.g., using PHP commands) to determine the specified optimization configuration (e.g., based on the value of the optimization_application_input_data field).

Optimization module calculations may be executed by the optimization module at 925. In one implementation, the retrieved security data, the determined optimization configuration, and/or the like may be utilized to perform the optimization module calculations (e.g., MVO via Gurobi) associated with the optimization request that are implemented by the optimization module.

Optimization module execution results may be provided for the requestor at 929. For example, optimal asset weights for the specified portfolio assets, optimal portfolio expected return, data specifying charts of efficient frontiers, and/or the like may be provided. In one implementation, the optimization module execution results may be provided via an optimization module execution response.

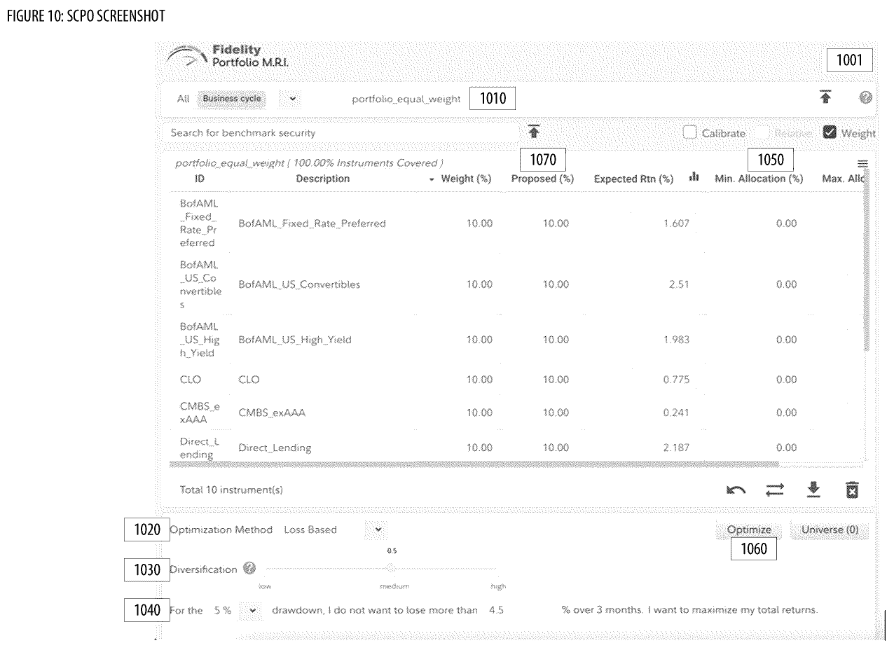

FIG. 10 shows non-limiting, example embodiments of a screenshot illustrating user interface(s) of the SCPO. In FIG. 10, an exemplary user interface (e.g., for a mobile device, for a website) for an optimization application is illustrated. Screen 1001 shows that a user may utilize a portfolio selection widget 1010 to select a portfolio to optimize. It is to be understood that, in an alternative embodiment, the user may specify individual securities instead of selecting an existing portfolio. The user may utilize an optimization method selection widget 1020 to select an optimization method (e.g., corresponding to an optimization module) to use. The user may also specify customized constrains such as via a widget 1030 to select a diversification level, via a widget 1040 to select a risk tolerance level, via a widget 1050 to select a minimum (and/or a maximum) allocation percentage for each security in the portfolio, and/or the like. The user may utilize an optimization execution widget 1060 to execute the optimization application. The user may view the optimization results for each security in the portfolio via proposed allocation percentage widget 1070.

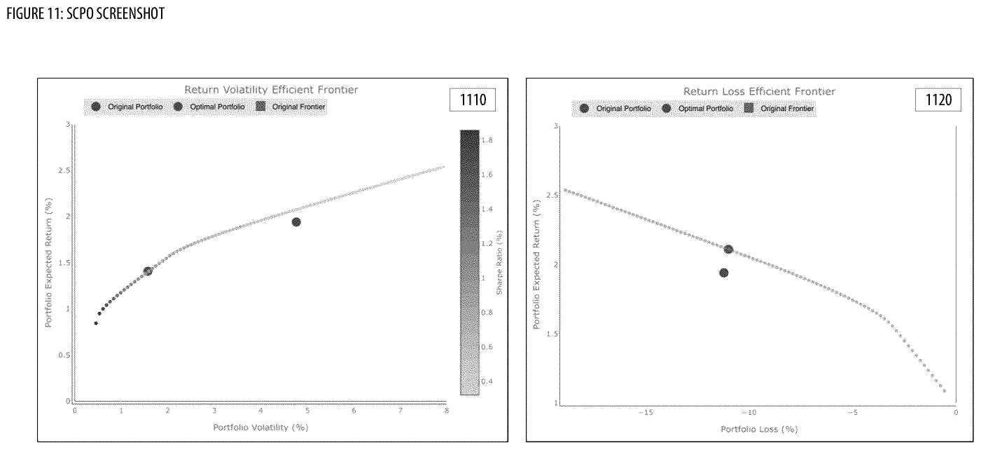

FIG. 11 shows non-limiting, example embodiments of a screenshot illustrating user interface(s) of the SCPO. In FIG. 11, an exemplary user interface (e.g., for a mobile device, for a website) showing charts of efficient frontiers that may be generated via an optimization application is illustrated. Screen 1110 shows a chart of a return volatility efficient frontier generated via MVO. Screen 1120 shows a chart of a return loss efficient frontier generated via TRO.

The optimization application may provide the frontiers in which each point has a corresponding pair of return and risk. The investors can utilize such frontiers to choose the efficient portfolio that satisfies their specific return objectives (e.g., the red point). Compared to the initial portfolio (e.g., the green point), the optimization application may provide a better portfolio that has a higher return and/or lower risk.

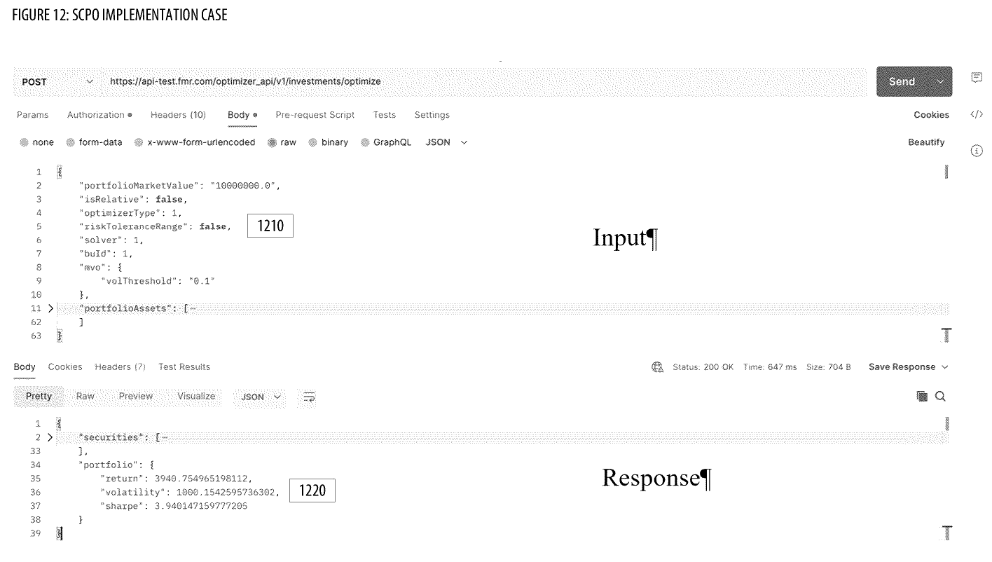

FIG. 12 shows non-limiting, example embodiments of implementation case(s) for the SCPO. In FIG. 12, exemplary input datastructure 1210 and response datastructure 1220 of a serverless optimization API call (e.g., a RESTful API call) utilized to execute a portfolio optimization application is illustrated using Postman client.

FIG. 13 shows non-limiting, example embodiments of implementation case(s) for the SCPO. In FIG. 13, exemplary input datastructure 1310 and response datastructure 1320 of an API call (e.g., a RESTful API call) to fetch asset return distribution data (e.g., for a specified portfolio and/or for a specified benchmark portfolio) from Aerospike is illustrated using Postman client.

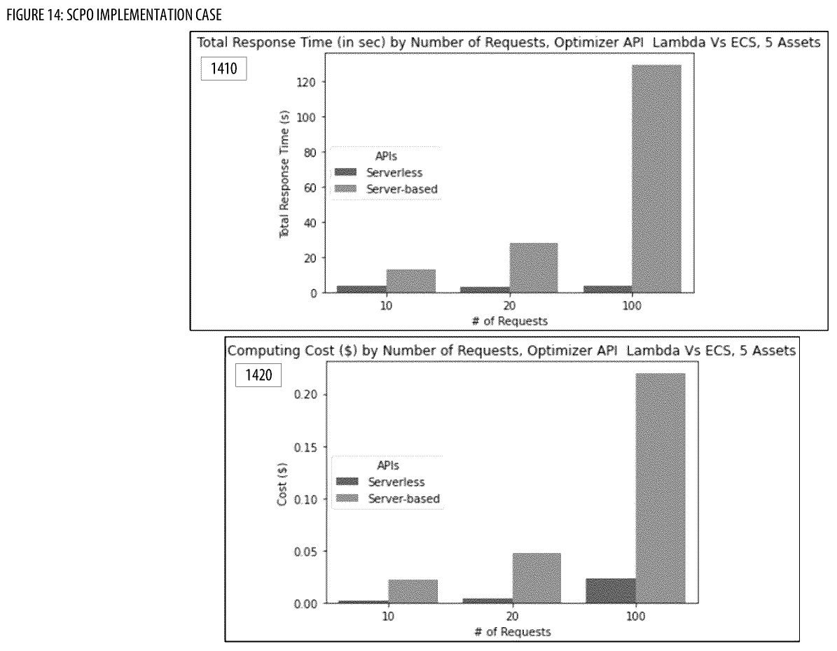

FIG. 14 shows non-limiting, example embodiments of implementation case(s) for the SCPO. In FIG. 14, an exemplary performance and resource consumption comparison is illustrated. To test the performance, we compare a server-based optimizer API, deployed in an AWS EC2 machine with 16 vCPU, 32 GB memory (c5.4xlarge), with a compatible Lambda Function optimizer API using 4 GB memory. The Lambda Function-based API can better handle large volume of requests. Since there is no built-in scaling mechanism in the server-based optimizer API, it fails when there are more than 300 concurrent API requests, while the Lambda Function-based API returns the responses for all requests successfully. Also, the Lambda Function-based API performs faster than the server-based API. To compare the response speed, we reduced the maximum number of concurrent requests to 100 and the following is the result of comparing the two APIs for MVO optimizer with Gurobi solver, with 5 total assets in the portfolio. Screen 1410 shows that the Lambada Function-based optimizer API is faster than server-based API, with regard to the average response time for 10, 20 and 100 concurrent requests. Since Lambda Function has a default concurrency of 1000, the total response times for 10, 20, 100 requests are almost identical. Screen 1420 shows that the Lambda function-based APIs are more resource-efficient per execution. Since AWS Lambda Function is only billed for its execution time, and the server-based approach is billed all the time even when it is idle, the AWS Lambda Function is a more resource-efficient solution compared to the server-based approach.

### Additional Alternative Embodiment Examples

The following alternative example embodiments provide a number of variations of some of the already discussed principles for expanded color on the abilities of the SCPO.

Additional embodiments may include:
1. An optimization application configuring apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
   generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
   generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
   provide, via the at least one processor, the first optimization configuration datastructure and the second optimization configuration datastructure to a cloud configuration server, in which the cloud configuration server is structured as initializing the application load balancer in accordance with the provided optimization configuration datastructures.
2. The apparatus of embodiment 1, in which the component collection storage is further structured with processor-executable instructions, comprising:
   provide, via the at least one processor, a first deployment package associated with the first cloud function to the cloud configuration server; and
   provide, via the at least one processor, a second deployment package associated with the second cloud function to the cloud configuration server.
3. The apparatus of embodiment 1, in which the first optimization configuration datastructure is structured as specifying a first cloud function dependency, and in which the second optimization configuration datastructure is structured as specifying a second cloud function dependency.
4. The apparatus of embodiment 3, in which the component collection storage is further structured with processor-executable instructions, comprising:
   provide, via the at least one processor, a first dependency deployment package associated with the first cloud function dependency to the cloud configuration server; and
   provide, via the at least one processor, a second dependency deployment package associated with the second cloud function dependency to the cloud configuration server.
5. The apparatus of embodiment 4, in which the first dependency deployment package and the second dependency deployment package share a common code base.
6. The apparatus of embodiment 1, in which the optimization application configuration request is structured as specifying cached data repository settings for the optimization application.
7. The apparatus of embodiment 6, in which the cached data repository settings are structured to specify an IP address and a port of a cached data repository, in which the cached data repository is structured as storing data retrieved from a set of source data repositories and transformed into a cached data format utilized by the optimization application.
8. The apparatus of embodiment 6, in which the first optimization configuration datastructure is structured as specifying the cached data repository settings, and in which the second optimization configuration datastructure is structured as specifying the cached data repository settings.
9. The apparatus of embodiment 1, in which the first optimization configuration datastructure is structured as specifying a first number of concurrent cloud function instances for the first cloud function, and in which the second optimization configuration datastructure is structured as specifying a second number of concurrent cloud function instances for the second cloud function.
10. The apparatus of embodiment 9, in which the first number of concurrent cloud function instances and the second number of concurrent cloud function instances are identical.
11. The apparatus of embodiment 1, in which the first optimization configuration datastructure is structured as specifying first runtime environment settings, and in which the second optimization configuration datastructure is structured as specifying second runtime environment settings.
12. The apparatus of embodiment 1, in which the application load balancer is structured as triggering execution of the first cloud function in response to the request specifying the first API path on an instance of the first cloud function that depends on a requester's region.
13. The apparatus of embodiment 1, in which the component collection storage is further structured with processor-executable instructions, comprising:
   generate, via the at least one processor, a third optimization configuration datastructure for a third optimization module from the plurality of optimization modules, in which the third optimization configuration datastructure is structured as specifying a third cloud function for the third optimization module, a third API path for the third optimization module, and the identifier of the application load balancer to utilize for the optimization application, in which the application load balancer is structured as triggering execution of the third cloud function in response to a request specifying the third API path, in which the first optimization module and the third optimization module utilize an identical optimizer; and
   provide, via the at least one processor, the third optimization configuration datastructure to the cloud configuration server.
14. The apparatus of embodiment 13, in which the component collection storage is further structured with processor-executable instructions, comprising:
   generate, via the at least one processor, a fourth optimization configuration datastructure for a fourth optimization module from the plurality of optimization modules, in which the fourth optimization configuration datastructure is structured as specifying a fourth cloud function for the fourth optimization module, a fourth API path for the fourth optimization module, and the identifier of the application load balancer to utilize for the optimization application, in which the application load balancer is structured as triggering execution of the fourth cloud function in response to a request specifying the fourth API path, in which the fourth optimization module and the second optimization module utilize an identical solver; and
   provide, via the at least one processor, the fourth optimization configuration datastructure to the cloud configuration server.
15. The apparatus of embodiment 1, in which the optimization application is a portfolio optimizer structured as utilizing a set of security identifiers as an input.
16. An optimization application configuring processor-readable, non-transient medium, the medium storing a component collection, the component collection storage structured with processor-executable instructions comprising:
   obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
   generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
   generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
   provide, via the at least one processor, the first optimization configuration datastructure and the second optimization configuration datastructure to a cloud configuration server, in which the cloud configuration server is structured as initializing the application load balancer in accordance with the provided optimization configuration datastructures.
17. The medium of embodiment 16, in which the component collection storage is further structured with processor-executable instructions, comprising:
   provide, via the at least one processor, a first deployment package associated with the first cloud function to the cloud configuration server; and
   provide, via the at least one processor, a second deployment package associated with the second cloud function to the cloud configuration server.
18. The medium of embodiment 16, in which the first optimization configuration datastructure is structured as specifying a first cloud function dependency, and in which the second optimization configuration datastructure is structured as specifying a second cloud function dependency.
19. The medium of embodiment 18, in which the component collection storage is further structured with processor-executable instructions, comprising:
   provide, via the at least one processor, a first dependency deployment package associated with the first cloud function dependency to the cloud configuration server; and
   provide, via the at least one processor, a second dependency deployment package associated with the second cloud function dependency to the cloud configuration server.
20. The medium of embodiment 19, in which the first dependency deployment package and the second dependency deployment package share a common code base.
21. The medium of embodiment 16, in which the optimization application configuration request is structured as specifying cached data repository settings for the optimization application.
22. The medium of embodiment 21, in which the cached data repository settings are structured to specify an IP address and a port of a cached data repository, in which the cached data repository is structured as storing data retrieved from a set of source data repositories and transformed into a cached data format utilized by the optimization application.
23. The medium of embodiment 21, in which the first optimization configuration datastructure is structured as specifying the cached data repository settings, and in which the second optimization configuration datastructure is structured as specifying the cached data repository settings.
24. The medium of embodiment 16, in which the first optimization configuration datastructure is structured as specifying a first number of concurrent cloud function instances for the first cloud function, and in which the second optimization configuration datastructure is structured as specifying a second number of concurrent cloud function instances for the second cloud function.
25. The medium of embodiment 24, in which the first number of concurrent cloud function instances and the second number of concurrent cloud function instances are identical.
26. The medium of embodiment 16, in which the first optimization configuration datastructure is structured as specifying first runtime environment settings, and in which the second optimization configuration datastructure is structured as specifying second runtime
27. The medium of embodiment 16, in which the application load balancer is structured as triggering execution of the first cloud function in response to the request specifying the first API path on an instance of the first cloud function that depends on a requester's region.
28. The medium of embodiment 16, in which the component collection storage is further structured with processor-executable instructions, comprising:
   generate, via the at least one processor, a third optimization configuration datastructure for a third optimization module from the plurality of optimization modules, in which the third optimization configuration datastructure is structured as specifying a third cloud function for the third optimization module, a third API path for the third optimization module, and the identifier of the application load balancer to utilize for the optimization application, in which the application load balancer is structured as triggering execution of the third cloud function in response to a request specifying the third API path, in which the first optimization module and the third optimization module utilize an identical optimizer; and
   provide, via the at least one processor, the third optimization configuration datastructure to the cloud configuration server.
29. The medium of embodiment 28, in which the component collection storage is further structured with processor-executable instructions, comprising:
   generate, via the at least one processor, a fourth optimization configuration datastructure for a fourth optimization module from the plurality of optimization modules, in which the fourth optimization configuration datastructure is structured as specifying a fourth cloud function for the fourth optimization module, a fourth API path for the fourth optimization module, and the identifier of the application load balancer to utilize for the optimization application, in which the application load balancer is structured as triggering execution of the fourth cloud function in response to a request specifying the fourth API path, in which the fourth optimization module and the second optimization module utilize an identical solver; and
   provide, via the at least one processor, the fourth optimization configuration datastructure to the cloud configuration server.
30. The medium of embodiment 16, in which the optimization application is a portfolio optimizer structured as utilizing a set of security identifiers as an input.
31. An optimization application configuring processor-implemented system, comprising:
means to store a component collection;
means to process processor-executable instructions from the component collection, the component collection storage structured with processor-executable instructions including:
   obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
   generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
   generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
   provide, via the at least one processor, the first optimization configuration datastructure and the second optimization configuration datastructure to a cloud configuration server, in which the cloud configuration server is structured as initializing the application load balancer in accordance with the provided optimization configuration datastructures.
32. The system of embodiment 31, in which the component collection storage is further structured with processor-executable instructions, comprising:
   provide, via the at least one processor, a first deployment package associated with the first cloud function to the cloud configuration server; and
   provide, via the at least one processor, a second deployment package associated with the second cloud function to the cloud configuration server.
33. The system of embodiment 31, in which the first optimization configuration datastructure is structured as specifying a first cloud function dependency, and in which the second optimization configuration datastructure is structured as specifying a second cloud function dependency.
34. The system of embodiment 33, in which the component collection storage is further structured with processor-executable instructions, comprising:
   provide, via the at least one processor, a first dependency deployment package associated with the first cloud function dependency to the cloud configuration server; and
   provide, via the at least one processor, a second dependency deployment package associated with the second cloud function dependency to the cloud configuration server.
35. The system of embodiment 34, in which the first dependency deployment package and the second dependency deployment package share a common code base.
36. The system of embodiment 31, in which the optimization application configuration request is structured as specifying cached data repository settings for the optimization application.
37. The system of embodiment 36, in which the cached data repository settings are structured to specify an IP address and a port of a cached data repository, in which the cached data repository is structured as storing data retrieved from a set of source data repositories and transformed into a cached data format utilized by the optimization application.
38. The system of embodiment 36, in which the first optimization configuration datastructure is structured as specifying the cached data repository settings, and in which the second optimization configuration datastructure is structured as specifying the cached data repository settings.
39. The system of embodiment 31, in which the first optimization configuration datastructure is structured as specifying a first number of concurrent cloud function instances for the first cloud function, and in which the second optimization configuration datastructure is structured as specifying a second number of concurrent cloud function instances for the second cloud function.
40. The system of embodiment 39, in which the first number of concurrent cloud function instances and the second number of concurrent cloud function instances are identical.
41. The system of embodiment 31, in which the first optimization configuration datastructure is structured as specifying first runtime environment settings, and in which the second optimization configuration datastructure is structured as specifying second runtime
42. The system of embodiment 31, in which the application load balancer is structured as triggering execution of the first cloud function in response to the request specifying the first API path on an instance of the first cloud function that depends on a requester's region.
43. The system of embodiment 31, in which the component collection storage is further structured with processor-executable instructions, comprising:
   generate, via the at least one processor, a third optimization configuration datastructure for a third optimization module from the plurality of optimization modules, in which the third optimization configuration datastructure is structured as specifying a third cloud function for the third optimization module, a third API path for the third optimization module, and the identifier of the application load balancer to utilize for the optimization application, in which the application load balancer is structured as triggering execution of the third cloud function in response to a request specifying the third API path, in which the first optimization module and the third optimization module utilize an identical optimizer; and
   provide, via the at least one processor, the third optimization configuration datastructure to the cloud configuration server.
44. The system of embodiment 43, in which the component collection storage is further structured with processor-executable instructions, comprising:
   generate, via the at least one processor, a fourth optimization configuration datastructure for a fourth optimization module from the plurality of optimization modules, in which the fourth optimization configuration datastructure is structured as specifying a fourth cloud function for the fourth optimization module, a fourth API path for the fourth optimization module, and the identifier of the application load balancer to utilize for the optimization application, in which the application load balancer is structured as triggering execution of the fourth cloud function in response to a request specifying the fourth API path, in which the fourth optimization module and the second optimization module utilize an identical solver; and
   provide, via the at least one processor, the fourth optimization configuration datastructure to the cloud configuration server.
45. The system of embodiment 31, in which the optimization application is a portfolio optimizer structured as utilizing a set of security identifiers as an input.
46. An optimization application configuring processor-implemented process, including processing processor-executable instructions via at least one processor from a component collection stored in at least one memory, the component collection storage structured with processor-executable instructions comprising:
   obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
   generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
   generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
   provide, via the at least one processor, the first optimization configuration datastructure and the second optimization configuration datastructure to a cloud configuration server, in which the cloud configuration server is structured as initializing the application load balancer in accordance with the provided optimization configuration datastructures.
47. The process of embodiment 46, in which the component collection storage is further structured with processor-executable instructions, comprising:
   provide, via the at least one processor, a first deployment package associated with the first cloud function to the cloud configuration server; and
   provide, via the at least one processor, a second deployment package associated with the second cloud function to the cloud configuration server.
48. The process of embodiment 46, in which the first optimization configuration datastructure is structured as specifying a first cloud function dependency, and in which the second optimization configuration datastructure is structured as specifying a second cloud function dependency.
49. The process of embodiment 48, in which the component collection storage is further structured with processor-executable instructions, comprising:
   provide, via the at least one processor, a first dependency deployment package associated with the first cloud function dependency to the cloud configuration server; and
   provide, via the at least one processor, a second dependency deployment package associated with the second cloud function dependency to the cloud configuration server.
50. The process of embodiment 49, in which the first dependency deployment package and the second dependency deployment package share a common code base.
51. The process of embodiment 46, in which the optimization application configuration request is structured as specifying cached data repository settings for the optimization application.
52. The process of embodiment 51, in which the cached data repository settings are structured to specify an IP address and a port of a cached data repository, in which the cached data repository is structured as storing data retrieved from a set of source data repositories and transformed into a cached data format utilized by the optimization application.
53. The process of embodiment 51, in which the first optimization configuration datastructure is structured as specifying the cached data repository settings, and in which the second optimization configuration datastructure is structured as specifying the cached data repository settings.
54. The process of embodiment 46, in which the first optimization configuration datastructure is structured as specifying a first number of concurrent cloud function instances for the first cloud function, and in which the second optimization configuration datastructure is structured as specifying a second number of concurrent cloud function instances for the second cloud function.
55. The process of embodiment 54, in which the first number of concurrent cloud function instances and the second number of concurrent cloud function instances are identical.
56. The process of embodiment 46, in which the first optimization configuration datastructure is structured as specifying first runtime environment settings, and in which the second optimization configuration datastructure is structured as specifying second runtime
57. The process of embodiment 46, in which the application load balancer is structured as triggering execution of the first cloud function in response to the request specifying the first API path on an instance of the first cloud function that depends on a requester's region.
58. The process of embodiment 46, in which the component collection storage is further structured with processor-executable instructions, comprising:
   generate, via the at least one processor, a third optimization configuration datastructure for a third optimization module from the plurality of optimization modules, in which the third optimization configuration datastructure is structured as specifying a third cloud function for the third optimization module, a third API path for the third optimization module, and the identifier of the application load balancer to utilize for the optimization application, in which the application load balancer is structured as triggering execution of the third cloud function in response to a request specifying the third API path, in which the first optimization module and the third optimization module utilize an identical optimizer; and
   provide, via the at least one processor, the third optimization configuration datastructure to the cloud configuration server.
59. The process of embodiment 58, in which the component collection storage is further structured with processor-executable instructions, comprising:
   generate, via the at least one processor, a fourth optimization configuration datastructure for a fourth optimization module from the plurality of optimization modules, in which the fourth optimization configuration datastructure is structured as specifying a fourth cloud function for the fourth optimization module, a fourth API path for the fourth optimization module, and the identifier of the application load balancer to utilize for the optimization application, in which the application load balancer is structured as triggering execution of the fourth cloud function in response to a request specifying the fourth API path, in which the fourth optimization module and the second optimization module utilize an identical solver; and
   provide, via the at least one processor, the fourth optimization configuration datastructure to the cloud configuration server.
60. The process of embodiment 46, in which the optimization application is a portfolio optimizer structured as utilizing a set of security identifiers as an input.

### SCPO Controller

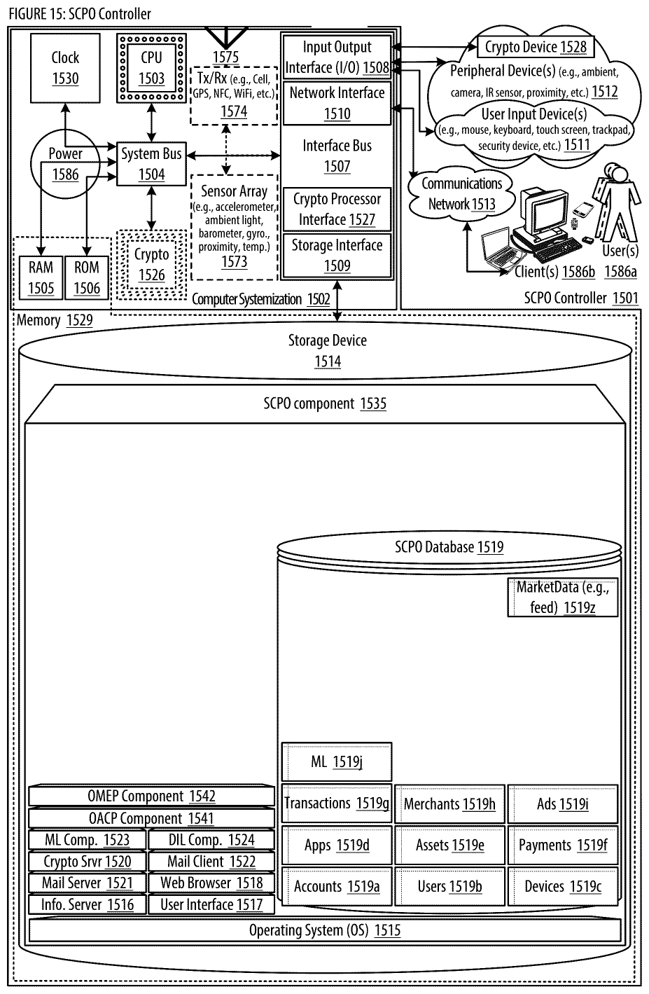

FIG. 15 shows a block diagram illustrating non-limiting, example embodiments of a SCPO controller. In this embodiment, the SCPO controller 1501 may serve to aggregate, process, store, search, serve, identify, instruct, generate, match, and/or facilitate interactions with a computer through cloud computing technologies, and/or other related data.

Users, which may be people and/or other systems, may engage information technology systems (e.g., computers) to facilitate information processing. In turn, computers employ processors to process information; such processors 1503 may be referred to as central processing units (CPU). One form of processor is referred to as a microprocessor. CPU's use communicative circuits to pass binary encoded signals acting as instructions to allow various operations. These instructions may be operational and/or data instructions containing and/or referencing other instructions and data in various processor accessible and operable areas of memory 1529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU′ circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SCPO controller 1501 may be connected to and/or communicate with entities such as, but not limited to: one or more users from peripheral devices 1512 (e.g., user input devices 1511); an optional cryptographic processor device 1528; and/or a communications network 1513.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LAN's), Pico networks, Wide Area Networks (WANs), Wireless Networks (WLANs), etc. For example, the Internet is, generally, an interconnection of a multitude of networks whereby remote clients and servers may access and interoperate with one another.

The SCPO controller 1501 may be based on computer systems that may comprise, but are not limited to, components such as: a computer systemization 1502 connected to memory 1529.

### Computer Systemization

A computer systemization 1502 may comprise a clock 1530, central processing unit (“CPU(s)” and/or “processor(s)” (these terms are used interchangeably throughout the disclosure unless noted to the contrary)) 1503, a memory 1529 (e.g., a read only memory (ROM) 1506, a random access memory (RAM) 1505, etc.), and/or an interface bus 1507, and most frequently, although not necessarily, are all interconnected and/or communicating through a system bus 1504 on one or more (mother) board(s) 1502 having conductive and/or otherwise transportive circuit pathways through which instructions (e.g., binary encoded signals) may travel to effectuate communications, operations, storage, etc. The computer systemization may be connected to a power source 1586; e.g., optionally the power source may be internal. Optionally, a cryptographic processor 1526 may be connected to the system bus. In another embodiment, the cryptographic processor, transceivers (e.g., ICs) 1574, and/or sensor array (e.g., accelerometer, altimeter, ambient light, barometer, global positioning system (GPS) (thereby allowing SCPO controller to determine its location), gyroscope, magnetometer, pedometer, proximity, ultra-violet sensor, etc.) 1573 may be connected as either internal and/or external peripheral devices 1512 via the interface bus I/O 1508 (not pictured) and/or directly via the interface bus 1507. In turn, the transceivers may be connected to antenna(s) 1575, thereby effectuating wireless transmission and reception of various communication and/or sensor protocols; for example the antenna(s) may connect to various transceiver chipsets (depending on deployment needs), including: Broadcom® BCM4329FKUBG transceiver chip (e.g., providing 802.11n, Bluetooth 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom® BCM43341 transceiver chip (e.g., providing 2G, 3G and 4G LTE cellular communications; 802.11g/, Bluetooth 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n (also known as WiFi in numerous iterations), Bluetooth 4.0 LE, FM, GPS; a Lapis Semiconductor® ML8511 UV sensor; a maxim integrated MAX44000 ambient light and infrared proximity sensor; a Texas Instruments® WiLink WL1283 transceiver chip (e.g., providing 802.11n, Bluetooth 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Google Glass®), watches, etc.), and/or the like. Often, the processors themselves may incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1529 beyond the processor itself; internal memory may include, but is not limited to: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon®, Duron® and/or Opteron®; Apple's® A series of processors (e.g., A5, A6, A7, A8, etc.); ARM's® application, embedded and secure processors; IBM® and/or Motorola's DragonBall® and PowerPC®; IBM's® and Sony's® Cell processor; Intel's® 80×86 series (e.g., 80386, 80486), Pentium®, Celeron®, Core (2) Duo®, i series (e.g., i3, i5, i7, i9, etc.), Itanium®, Xeon®, and/or XScale®; Motorola's® 680×0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU′ may read processor issuable instructions from memory (e.g., reading it from a component collection (e.g., an interpreted and/or compiled program application/library including allowing the processor to execute instructions from the application/library) stored in the memory). Such instruction passing facilitates communication within the SCPO controller and beyond through various interfaces. Should processing requirements dictate a greater amount speed and/or capacity, distributed processors (e.g., see Distributed SCPO below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the SCPO may be achieved by implementing a microcontroller such as CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the SCPO, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SCPO component collection (distributed or otherwise) and/or features may be implemented via the microprocessor and/or via embedded components; e.g., via ASIC, coprocessor, DSP, FPGA, and/or the like. Alternately, some implementations of the SCPO may be implemented with embedded components that are configured and used to achieve a variety of features or signal processing.

Depending on the particular implementation, the embedded components may include software solutions, hardware solutions, and/or some combination of both hardware/software solutions. For example, SCPO features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the SCPO features. A hierarchy of programmable interconnects allow logic blocks to be interconnected as needed by the SCPO system designer/administrator, somewhat like a one-chip programmable breadboard. An FPGA's logic blocks can be programmed to perform the operation of basic logic gates such as AND, and NOR, or more complex combinational operators such as decoders or mathematical operations. In most FPGAs, the logic blocks also include memory elements, which may be circuit flip-flops or more complete blocks of memory. In some circumstances, the SCPO may be developed on FPGAs and then migrated into a fixed version that more resembles ASIC implementations. Alternate or coordinating implementations may migrate SCPO controller features to a final ASIC instead of or in addition to FPGAs. Depending on the implementation all of the aforementioned embedded components and microprocessors may be considered the “CPU” and/or “processor” for the SCPO.

### Power Source

The power source 1586 may be of any various form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1586 is connected to at least one of the interconnected subsequent components of the SCPO thereby providing an electric current to all subsequent components. In one example, the power source 1586 is connected to the system bus component 1504. In an alternative embodiment, an outside power source 1586 is provided through a connection across the I/O 1508 interface. For example, Ethernet (with power on Ethernet), IEEE 1394, USB and/or the like connections carry both data and power across the connection and is therefore a suitable source of power.

### Interface Adapters

Interface bus(ses) 1507 may accept, connect, and/or communicate to a number of interface adapters, variously although not necessarily in the form of adapter cards, such as but not limited to: input output interfaces (I/O) 1508, storage interfaces 1509, network interfaces 1510, and/or the like. Optionally, cryptographic processor interfaces 1527 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1509 may accept, communicate, and/or connect to a number of storage devices such as, but not limited to: (removable) storage devices 1514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Non-Volatile Memory (NVM) Express (NVMe), Small Computer Systems Interface (SCSI), Thunderbolt, Universal Serial Bus (USB), and/or the like.

Network interfaces 1510 may accept, communicate, and/or connect to a communications network 1513. Through a communications network 1513, the SCPO controller is accessible through remote clients 1533b (e.g., computers with web browsers) by users 1533a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed SCPO below), architectures may similarly be employed to pool, load balance, and/or otherwise decrease/increase the communicative bandwidth required by the SCPO controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1510 may be used to engage with various communications network types 1513. For example, multiple network interfaces may be employed to allow for the communication over broadcast, multicast, and/or unicast networks.

Input Output interfaces (I/O) 1508 may accept, communicate, and/or connect to user, peripheral devices 1512 (e.g., input devices 1511), cryptographic processor devices 1528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt/USB-C, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 1512 may be connected and/or communicate to I/O and/or other facilities of the like such as network interfaces, storage interfaces, directly to the interface bus, system bus, the CPU, and/or the like. Peripheral devices may be external, internal and/or part of the SCPO controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1511 often are a type of peripheral device 512 (see above) and may include: accelerometers, cameras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the SCPO controller may be embodied as an embedded, dedicated, and/or monitor-less (i.e., headless) device, and access may be provided over a network interface connection.

Cryptographic units such as, but not limited to, microcontrollers, processors 1526, interfaces 1527, and/or devices 1528 may be attached, and/or communicate with the SCPO controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include: Broadcom's® Crypto. NetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VISI Technology's® 33 MHz 6868; and/or the like.

### Memory

Generally, any mechanization and/or embodiment allowing a processor to affect the storage and/or retrieval of information is regarded as memory 1529. The storing of information in memory may result in a physical alteration of the memory to have a different physical state that makes the memory a structure with a unique encoding of the memory stored therein. Often, memory is a fungible technology and resource, thus, any number of memory embodiments may be employed in lieu of or in concert with one another. It is to be understood that the SCPO controller and/or a computer systemization may employ various forms of memory 1529. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 1529 may include ROM 1506, RAM 1505, and a storage device 1514. A storage device 1514 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU′), solid state memory devices (USB memory, solid state drives (SSD), etc.); other processor-readable storage mediums; and/or other devices of the like. Thus, a computer systemization generally employs and makes use of memory.

### Component Collection

The memory 1529 may contain a collection of processor-executable application/library/program and/or database components (e.g., including processor-executable instructions) and/or data such as, but not limited to: operating system component(s) 1515 (operating system); information server component(s) 1516 (information server); user interface component(s) 1517 (user interface); Web browser component(s) 1518 (Web browser); database(s) 1519; mail server component(s) 1521; mail client component(s) 1522; cryptographic server component(s) 1520 (cryptographic server); machine learning component 1523; distributed immutable ledger component 1524; the SCPO component(s) 1535 (e.g., which may include OACP, OMEP 1541-1542, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 1514, they may also be loaded and/or stored in memory such as: cache, peripheral devices, processor registers, RAM, remote storage facilities through a communications network, ROM, various forms of memory, and/or the like.

### Operating System

The operating system component 1515 is an executable program component facilitating the operation of the SCPO controller. The operating system may facilitate access of I/O, network interfaces, peripheral devices, storage devices, and/or the like. The operating system may be a highly fault tolerant, scalable, and secure system such as: Apple's Macintosh OS X (Server) and macOS®; AT&T Plan 9®; Be OS®; Blackberry's QNX®; Google's Chrome®; Microsoft's Windows® Jul. 8, 2010; Unix and Unix-like system distributions (such as AT&T's UNIX®; Berkley Software Distribution (BSD)® variations such as FreeBSD®, NetBSD, OpenBSD, and/or the like; Linux distributions such as Red Hat, Ubuntu, and/or the like); and/or the like operating systems. However, more limited and/or less secure operating systems also may be employed such as Apple Macintosh OS® (i.e., versions 1-9), IBM OS/2®, Microsoft DOS®, Microsoft Windows 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as: Apple's iOS®; China Operating System COS®; Google's Android®; Microsoft Windows RT/Phone®; Palm's WebOS®; Samsung/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the SCPO controller to communicate with other entities through a communications network 1513. Various communication protocols may be used by the SCPO controller as a subcarrier transport mechanism for interaction, such as, but not limited to: multicast, TCP/IP, UDP, unicast, and/or the like.

### Information Server

An information server component 1516 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C(++), C # and/or .NET, Common Gateway Interface (CGI) scripts, dynamic (D) hypertext markup language (HTML), FLASH, Java, JavaScript, Practical Extraction Report Language (PERL.), Hypertext Pre-Processor (PHP), pipes, Python, Ruby, wireless application protocol (WAP), WebObjects®, and/or the like. The information server may support secure communications protocols such as, but not limited to, File Transfer Protocol (FTP(S)); Hyper Text Transfer Protocol (HTTP); Secure Hypertext Transfer Protocol (HTTPS), Secure Socket Layer (SSL) Transport Layer Security (TLS), messaging protocols (e.g., America Online (AOL) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SCPO controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SCPO database 1519, operating systems, other program components, user interfaces, Web browsers, and/or the like.

Access to the SCPO database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SCPO. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the SCPO as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D) HTML, FLASH, Java, JavaScript, etc. interface libraries such as, but not limited to, Dojo, jQuery (UI), MooTools, Prototype, script.aculo.us, SWFObject, Yahoo! User Interface®, and/or the like, any of which may be used and) provide a baseline and mechanism of accessing and displaying information graphically to users.

A user interface component 1517 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1518 is a stored program component that is executed by a CPU. The Web browser may be a hypertext viewing application such as Apple's (mobile) Safari®, Google's Chrome®, Microsoft Internet Explorer®, Mozilla's Firefox®, Netscape Navigator®, and/or the like. Secure Web browsing may be supplied with 128 bit (or greater) encryption by way of HTTPS, SSL, and/or the like. Web browsers allowing for the execution of program components through facilities such as ActiveX, AJAX, (D) HTML, FLASH, Java, JavaScript, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SCPO enabled nodes. The combined application may be nugatory on systems employing Web browsers.

### Mail Server

A mail server component 1521 is a stored program component that is executed by a CPU 1503. The mail server may be an Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C(++), C # and/or .NET, CGI scripts, Java, JavaScript, PERL, PHP, pipes, Python, WebObjects®, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SCPO. Alternatively, the mail server component may be distributed out to mail service providing entities such as Google's® cloud services (e.g., Gmail and notifications may alternatively be provided via messenger services such as AOL's Instant Messenger®, Apple's iMessage®, Google Messenger®, SnapChat®, etc.).

Access to the SCPO mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1522 is a stored program component that is executed by a CPU 1503. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1520 is a stored program component that is executed by a CPU 1503, cryptographic processor 1526, cryptographic processor interface 1527, cryptographic processor device 1528, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the SCPO may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the SCPO component to engage in secure transactions if so desired. The cryptographic component facilitates the secure accessing of resources on the SCPO and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the SCPO includes a machine learning component 1523, which may be a stored program component that is executed by a CPU 1503. The machine learning component, alternatively, may run on a set of specialized processors, ASICS, FPGAs, GPU's, and/or the like. The machine learning component may be deployed to execute serially, in parallel, distributed, and/or the like, such as by utilizing cloud computing. The machine learning component may employ an ML platform such as Amazon SageMaker, Azure Machine Learning, DataRobot AI Cloud, Google AI Platform, IBM Watson® Studio, and/or the like. The machine learning component may be implemented using an MI, framework such as PyTorch, Apache MANet, MathWorks Deep Learning Toolbox, scikit-learn, TensorFlow, XGBoost, and/or the like. The machine learning component facilitates training and/or testing of ML prediction logic data structures (e.g., models) and/or utilizing MI, prediction logic data structures (e.g., models) to output ML predictions by the SCPO. The machine learning component may employ various artificial intelligence and/or learning mechanisms such as Reinforcement Learning, Supervised Learning, Unsupervised Learning, and/or the like. The machine learning component may employ MI, prediction logic data structure (e.g., model) types such as Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the SCPO includes a distributed immutable ledger component 1524, which may be a stored program component that is executed by a CPU 1503. The distributed immutable ledger component, alternatively, may run on a set of specialized processors, ASICs, FPGAs, GPUs, and/or the like. The distributed immutable ledger component may be deployed to execute serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as Bitcoin, Bitcoin Cash, Dogecoin, Ethereum, Litecoin, Monero, Zcash, and/or the like. The distributed immutable ledger component may employ a consensus mechanism such as proof of authority, proof of space, proof of steak, proof of work, and/or the like. The distributed immutable ledger component may be used to provide functionality such as data storage, cryptocurrency, inventory tracking, non-fungible tokens (NFTs), smart contracts, and/or the like.

### The SCPO Database

The SCPO database component 1519 may be embodied in a database and its stored data. The database is a stored program component, which is executed by the CPU; the stored program component portion configuring the CPU to process the stored data. The database may be a fault tolerant, relational, scalable, secure database such as Claris File Maker®, MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the SCPO database may be implemented using various other data-structures, such as an array, hash, (linked) list, struct, structured text file (e.g., XML), table, flat file database, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SCPO database is implemented as a data-structure, the use of the SCPO database 1519 may be integrated into another component such as the SCPO component 1535. Also, the database may be implemented as a mix of data structures, objects, programs, relational structures, scripts, and/or the like. Databases may be consolidated and/or distributed in countless variations (e.g., see Distributed SCPO below). Portions of databases, e.g., tables, may be exported and/or imported and thus decentralized and/or integrated.

In another embodiment, the database component (and/or other storage mechanism of the SCPO) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DII, 1524 mechanism.

In one embodiment, the database component 1519 includes several tables representative of the schema, tables, structures, keys, entities and relationships of the described database 1519a-z:
An accounts table 1519a includes fields such as, but not limited to: an accountID), accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, account Number, routing Number, link WalletsID, accountPrioritAccaountRatio, account Address, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;
A users table 1519b includes fields such as, but not limited to: a userID, userSSN, taxID), userContactID, accountID, assetIDs, deviceIDs, paymentIDs, transactionIDs, user Type (e.g., agent, entity (e.g., corporate, non-profit, partnership, etc.), individual, etc.), namePrefix, first Name, middle Name, last Name, nameSuffix, DateOfBirth, userAge, userName, userEmail, userSocialAccountID), contactType, contactRelationship, userPhone, user Address, userCity, userState, userZIPCode, userCountry, user AuthorizationCode, userAccessPrivilges, userPreferences, userRestrictions, and/or the like (the user table may support and/or track multiple entity accounts on a SCPO);
An devices table 1519c includes fields such as, but not limited to: deviceID, sensorIDs, accountID, assetIDs, paymentIDs, deviceType, device Name, device Manufacturer, device. Model, device Version, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletApp InstalledFlag, device AccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;
An apps table 1519d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;
An assets table 1519e includes fields such as, but not limited to: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, asset TargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, assetAPI, assetAPIconnectionAddress, and/or the like;
A payments table 1519f includes fields such as, but not limited to: paymentID, accountID, userID, couponID, coupon Value, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;
An transactions table 1519g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;
An merchants table 1519h includes fields such as, but not limited to: merchantID, merchantTaxID), merchanteName, merchantContactUserID), accountID), issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;
An ads table 1519i includes fields such as, but not limited to: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerIP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetric Value, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID), merchantID), deviceID, userID, accountID), impressionID, impressionOS, impressionTimeStamp, impressionGeo, impressionAction, impressionType, impressionPublisherID, impressionPublisherURL, and/or the like;
An ML, table 1519j includes fields such as, but not limited to: MLID, predictionLogicStructureID, predictionLogicStructureType, predictionLogicStructureConfiguration, predictionLogicStructureTrainedStructure, predictionLogicStructureTrainingData, predictionLogicStructureTrainingDataConfiguration, predictionLogicStructureTestingData, predictionLogicStructureTestingDataConfiguration, predictionLogicStructureOutputData, predictionLogicStructureOutputDataConfiguration, and/or the like;
A market_data table 1519z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the SCPO database may interact with other database systems. For example, employing a distributed database system, queries and data access by search SCPO component may treat the combination of the SCPO database, an integrated data security layer database as a single database entity (e.g., see Distributed SCPO below).

In one embodiment, user programs may contain various user interface primitives, which may serve to update the SCPO. Also, various accounts may require custom database tables depending upon the environments and the types of clients the SCPO may need to serve. It should be noted that any unique fields may be designated as a key field throughout. In an alternative embodiment, these tables have been decentralized into their own databases and their respective database controllers (i.e., individual database controllers for each of the above tables). The SCPO may also be configured to distribute the databases over several computer systemizations and/or storage devices. Similarly, configurations of the decentralized database controllers may be varied by consolidating and/or distributing the various database components 1519a-z. The SCPO may be configured to keep track of various settings, inputs, and parameters via database controllers.

The SCPO database may communicate to and/or with other components in a component collection, including itself, and/or facilities of the like. Most frequently, the SCPO database communicates with the SCPO component, other program components, and/or the like. The database may contain, retain, and provide information regarding other nodes and data.

### The SCPOs

The SCPO component 1535 is a stored program component that is executed by a CPU via stored instruction code configured to engage signals across conductive pathways of the CPU and ISICI controller components. In one embodiment, the SCPO component incorporates any and/or all combinations of the aspects of the SCPO that were discussed in the previous figures. As such, the SCPO affects accessing, obtaining and the provision of information, services, transactions, and/or the like across various communications networks. The features and embodiments of the SCPO discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the SCPO's features and facilities, and in many cases reduce the costs, energy consumption/requirements, and extend the life of SCPO's underlying infrastructure; this has the added benefit of making the SCPO more reliable. Similarly, many of the features and mechanisms are designed to be easier for users to use and access, thereby broadening the audience that may enjoy/employ and exploit the feature sets of the SCPO; such ease of use also helps to increase the reliability of the SCPO. In addition, the feature sets include heightened security as noted via the Cryptographic components 1520, 1526, 1528 and throughout, making access to the features and data more reliable and secure

The SCPO transforms optimization application configuration input, optimization application execution input datastructure/inputs, via SCPO components (e.g., OACP, OMEP), into optimization application configuration output, optimization application execution output outputs.

The SCPO component facilitates access of information between nodes may be developed by employing various development tools and languages such as, but not limited to: Apache® components, Assembly, ActiveX, binary executables, (ANSI) (Objective-) C(++), C # and/or .NET, database adapters, CGI scripts, Java, JavaScript, mapping tools, procedural and object oriented development tools, PERL, PHP, Python, Ruby, shell scripts, SQL commands, web application server extensions, web development environments and libraries (e.g., Microsoft's® ActiveX; Adobe® AIR, FLEX & FLASH; AJAX; (D) HTML; Dojo, Java; JavaScript; jQuery (UI); MooTools; Prototype; script.aculo.us; Simple Object Access Protocol (SOAP); SWFObject; Yahoo!® User Interface; and/or the like), WebObjects®, and/or the like. In one embodiment, the SCPO server employs a cryptographic server to encrypt and decrypt communications. The SCPO component may communicate to and/or with other components in a component collection, including itself, and/or facilities of the like. Most frequently, the SCPO component communicates with the SCPO database, operating systems, other program components, and/or the like. The SCPO may contain, communicate, generate, obtain, and/or provide program component, system, user, and/or data communications, requests, and/or responses.

### Distributed SCPOs

The structure and/or operation of any of the SCPO node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

The component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part of sub parts of the SCPO node controller's component collection may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU′ core, then the next execution element of the component collection may be moved to execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. As such, it may be difficult to predict on which CPU and/or processing sub-unit a process instruction begins to execute and where it will continue and/or conclude execution, as it may be on the same or completely different CPU and/or processing sub-unit.

The configuration of the SCPO controller may depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services®, Microsoft Azure®, Hewlett Packard Helion®, IBM® Cloud services allow for SCPO controller and/or SCPO component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D) COM), (Distributed) Object Linking and Embedding ((D) OLE), and/or the like), Common Object Request Broker Architecture (CORBA), Jini local and remote application program interfaces, JavaScript Object Notation (JSON), NeXT Computer, Inc.'s (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
   where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration may depend upon the context, environment, and requirements of system deployment.

For example, in some implementations, the SCPO controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address');
socket_listen ($sock);
$client = socket_accept ($sock);
// read input data from client device in 1024 byte blocks until end of message
do {
  $input = “”;
  $input = socket_read($client, 1024);
  $data .= $input;
} while($input != “”);
// parse data to extract variables
$obj = json_decode($data, true);
// store input data in a database
mysql_connect(“201.408.185.132”,$DBserver,$password); // access database server
mysql_select (“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for Serverless Computing for Portfolio Optimization Apparatuses, Processes and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Further and to the extent any financial and/or investment examples are included, such examples are for illustrative purpose(s) only, and are not, nor should they be interpreted, as investment advice. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SCPO individual and/or enterprise user, database configuration and/or relational model, data type, data transmission and/or network framework, library, syntax structure, and/or the like, various embodiments of the SCPO, may be implemented that allow a great deal of flexibility and customization. For example, aspects of the SCPO may be adapted for general computationally demanding cases. While various embodiments and discussions of the SCPO have included cloud computing, however, it is to be understood that the embodiments described herein may be readily configured and/or customized for a wide variety of other applications and/or implementations.

What is claimed is:

1. An optimization application configuring apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
provide, via the at least one processor, the first optimization configuration datastructure and the second optimization configuration datastructure to a cloud configuration server, in which the cloud configuration server is structured as initializing the application load balancer in accordance with the provided optimization configuration datastructures.

2. The apparatus of claim 1, in which the component collection storage is further structured with processor-executable instructions, comprising:
provide, via the at least one processor, a first deployment package associated with the first cloud function to the cloud configuration server; and
provide, via the at least one processor, a second deployment package associated with the second cloud function to the cloud configuration server.

3. The apparatus of claim 1, in which the first optimization configuration datastructure is structured as specifying a first cloud function dependency, and in which the second optimization configuration datastructure is structured as specifying a second cloud function dependency.

4. The apparatus of claim 3, in which the component collection storage is further structured with processor-executable instructions, comprising:
provide, via the at least one processor, a first dependency deployment package associated with the first cloud function dependency to the cloud configuration server; and
provide, via the at least one processor, a second dependency deployment package associated with the second cloud function dependency to the cloud configuration server.

5. The apparatus of claim 4, in which the first dependency deployment package and the second dependency deployment package share a common code base.

6. The apparatus of claim 1, in which the optimization application configuration request is structured as specifying cached data repository settings for the optimization application.

7. The apparatus of claim 6, in which the cached data repository settings are structured to specify an IP address and a port of a cached data repository, in which the cached data repository is structured as storing data retrieved from a set of source data repositories and transformed into a cached data format utilized by the optimization application.

8. The apparatus of claim 6, in which the first optimization configuration datastructure is structured as specifying the cached data repository settings, and in which the second optimization configuration datastructure is structured as specifying the cached data repository settings.

9. The apparatus of claim 1, in which the first optimization configuration datastructure is structured as specifying a first number of concurrent cloud function instances for the first cloud function, and in which the second optimization configuration datastructure is structured as specifying a second number of concurrent cloud function instances for the second cloud function.

10. The apparatus of claim 9, in which the first number of concurrent cloud function instances and the second number of concurrent cloud function instances are identical.

11. The apparatus of claim 1, in which the first optimization configuration datastructure is structured as specifying first runtime environment settings, and in which the second optimization configuration datastructure is structured as specifying second runtime environment settings.

12. The apparatus of claim 1, in which the application load balancer is structured as triggering execution of the first cloud function in response to the request specifying the first API path on an instance of the first cloud function that depends on a requester's region.

13. The apparatus of claim 1, in which the component collection storage is further structured with processor-executable instructions, comprising:
generate, via the at least one processor, a third optimization configuration datastructure for a third optimization module from the plurality of optimization modules, in which the third optimization configuration datastructure is structured as specifying a third cloud function for the third optimization module, a third API path for the third optimization module, and the identifier of the application load balancer to utilize for the optimization application, in which the application load balancer is structured as triggering execution of the third cloud function in response to a request specifying the third API path, in which the first optimization module and the third optimization module utilize an identical optimizer; and
provide, via the at least one processor, the third optimization configuration datastructure to the cloud configuration server.

14. The apparatus of claim 13, in which the component collection storage is further structured with processor-executable instructions, comprising:
generate, via the at least one processor, a fourth optimization configuration datastructure for a fourth optimization module from the plurality of optimization modules, in which the fourth optimization configuration datastructure is structured as specifying a fourth cloud function for the fourth optimization module, a fourth API path for the fourth optimization module, and the identifier of the application load balancer to utilize for the optimization application, in which the application load balancer is structured as triggering execution of the fourth cloud function in response to a request specifying the fourth API path, in which the fourth optimization module and the second optimization module utilize an identical solver; and
provide, via the at least one processor, the fourth optimization configuration datastructure to the cloud configuration server.

15. The apparatus of claim 1, in which the optimization application is a portfolio optimizer structured as utilizing a set of security identifiers as an input.

16. An optimization application configuring processor-readable, non-transient medium, the medium storing a component collection, the component collection storage structured with processor-executable instructions comprising:
obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
provide, via the at least one processor, the first optimization configuration datastructure and the second optimization configuration datastructure to a cloud configuration server, in which the cloud configuration server is structured as initializing the application load balancer in accordance with the provided optimization configuration datastructures.

17. An optimization application configuring processor-implemented system, comprising:
means to store a component collection;
means to process processor-executable instructions from the component collection, the component collection storage structured with processor-executable instructions including:
obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
provide, via the at least one processor, the first optimization configuration datastructure and the second optimization configuration datastructure to a cloud configuration server, in which the cloud configuration server is structured as initializing the application load balancer in accordance with the provided optimization configuration datastructures.

18. An optimization application configuring processor-implemented process, including processing processor-executable instructions via at least one processor from a component collection stored in at least one memory, the component collection storage structured with processor-executable instructions comprising:
obtain, via the at least one processor, an optimization application configuration request associated with an optimization application, in which the optimization application configuration request is structured as specifying a plurality of optimization modules to configure for the optimization application, in which an optimization module corresponds to an optimization configuration comprising a distinct combination of an optimizer and a solver;
generate, via the at least one processor, a first optimization configuration datastructure for a first optimization module from the plurality of optimization modules, in which the first optimization configuration datastructure is structured as specifying a first cloud function for the first optimization module, a first API path for the first optimization module, and an identifier of an application load balancer to utilize for the optimization application, in which the application load balancer is structured as triggering execution of the first cloud function in response to a request specifying the first API path;
generate, via the at least one processor, a second optimization configuration datastructure for a second optimization module from the plurality of optimization modules, in which the second optimization configuration datastructure is structured as specifying a second cloud function for the second optimization module, a second API path for the second optimization module, and the identifier of the application load balancer to utilize for the optimization application, in which the application load balancer is structured as triggering execution of the second cloud function in response to a request specifying the second API path; and
provide, via the at least one processor, the first optimization configuration datastructure and the second optimization configuration datastructure to a cloud configuration server, in which the cloud configuration server is structured as initializing the application load balancer in accordance with the provided optimization configuration datastructures.
